(19) United States
(12) Patent Application Publication
(10) Pub. No.: US 2018/0069906 A1
(43) Pub. Date: Mar. 8, 2018

(54) METHOD AND SYSTEM FOR PRIVATE COMMUNICATION WITH MULTIPLE PARTIES

(71) Applicant: Alibaba Group Holding Limited, George Town (KY)

(72) Inventors: Boyu Yang, Hangzhou (CN); Xinglin Ma, Hangzhou (CN); Ming Zhang, Hangzhou (CN); Hailong Yao, Hangzhou (CN); Yun Chen, Hangzhou (CN); Weinan He, Hangzhou (CN); Huachen Liu, Hangzhou (CN); Zhengfu Li, Hangzhou (CN)

(73) Assignee: Alibaba Group Holding Limited, George Town (KY)

(21) Appl. No.: 15/691,506

(22) Filed: Aug. 30, 2017

(30) Foreign Application Priority Data
Sep. 5, 2016 (CN) 201610804884.5

(51) Int. Cl. H04L 29/06; H04L 12/58; H04W 4/14

(52) U.S. Cl. CPC H04L 65/403; G08B 21/24; H04W 4/14; H04L 51/12

(57) ABSTRACT

Embodiments of the present application provide a method and system for communication. During operation, the system may receive a message sent by a sender to multiple recipients. The system may determine that a reply mode of the message is set to a private mode which restricts permission to receive replies to the message. The system may receive a reply message sent by a recipient in response to the message. The system may identify, among the sender and the multiple recipients, a communication party with permission to receive the reply message. The system may then send the reply message to the identified communication party.

### RELATED APPLICATION

Under 35 U.S.C. 119, this application claims the benefits and rights of priority of Chinese Patent Application No. 201610804884.5, filed 5 Sep. 2016.

### BACKGROUND

### Field

The present disclosure relates to communication technology, and particularly relates to a method and system for private communication with multiple parties.

### Related Art

With existing communication systems, a sending party may send a message and message recipients may respond to the message. Such systems typically provide a symmetrical communication approach in which all communication parties, including the sending party and all message recipients, receive and view reply messages when any recipient replies to the message.

However, the symmetrical communication approach may present information security issues since the recipients may not desire to have their reply messages viewed by each other.

In order to avoid the information security issues, the recipients may create separate communication sessions with the sending party to send reply messages. However, this may result in low communication efficiency. The sending party may need to repeatedly switch between different communication sessions to separately communicate with each of the recipients. Unfortunately, the inconvenience of switching between the communication sessions and the low communication efficiency may result in a less desirable user experience.

### SUMMARY

One embodiment described herein includes a system for communication. During operation, the system may receive a message sent by a sender to multiple recipients. The system may determine that a reply mode of the message is set to a private mode which restricts permission to receive replies to the message. The system may receive a reply message sent by a recipient in response to the message. The system may then identify, among the sender and the multiple recipients, a communication party with permission to receive the reply message. The system may then send the reply message to the identified communication party.

### BRIEF DESCRIPTION OF THE DRAWINGS

The accompanying drawings described herein are used for further understanding the present application and constitute a part of the present application, and the schematic embodiments of the present application and the descriptions thereof are used for interpreting the present application, rather than improperly limiting the present application. In which:

FIG. 1 presents a diagram illustrating an exemplary computing system for private communication with multiple parties, in accordance with an embodiment.

FIG. 2 presents a flowchart illustrating an exemplary process for private communication with multiple parties, in accordance with an embodiment.

FIG. 3 presents a flowchart illustrating an exemplary process for a messaging communication method, in accordance with an embodiment.

FIG. 4 presents a schematic diagram illustrating an exemplary reminder message creation page, in accordance with an embodiment.

FIG. 5 presents a schematic diagram illustrating an exemplary reminder message creation page, in accordance with an embodiment.

FIG. 6 presents a schematic diagram illustrating an exemplary details page for recipient 1 or recipient 2, in accordance with an embodiment.

FIG. 7 presents a schematic diagram illustrating an exemplary details page for recipient 1, in accordance with an embodiment

FIG. 8 presents a schematic diagram illustrating an exemplary details page for the sender, in accordance with an embodiment.

FIG. 9 presents a schematic diagram illustrating an exemplary details page for recipient 2, in accordance with an embodiment.

FIG. 10 presents a schematic diagram illustrating an exemplary details page for the sender, in accordance with an embodiment.

FIG. 11 presents a schematic diagram illustrating an exemplary details page for the sender, in accordance with an embodiment.

FIG. 12 presents a schematic diagram illustrating an exemplary details page for recipient 1, in accordance with an embodiment.

FIG. 13 presents a schematic diagram illustrating an exemplary details page for recipient 2, in accordance with an embodiment

FIG. 14 presents a schematic diagram illustrating an exemplary details page for the sender, in accordance with an embodiment.

FIG. 15 presents a schematic diagram illustrating an exemplary details page for recipient 1, in accordance with an embodiment.

FIG. 16 presents a flowchart illustrating an exemplary process for a cross-enterprise group communication method, in accordance with an embodiment.

FIG. 17 presents a schematic diagram illustrating an exemplary group setup page, in accordance with an embodiment.

FIG. 18 presents a schematic diagram illustrating an exemplary group chat page for the sender, in accordance with an embodiment.

FIG. 19 presents a schematic diagram illustrating an exemplary group chat page for recipient 1, in accordance with an embodiment.

FIG. 20 presents a schematic diagram illustrating an exemplary group chat page for the sender, in accordance with an embodiment.

FIG. 21 presents a schematic diagram illustrating an exemplary group chat page for the sender, in accordance with an embodiment.

FIG. 22 presents a schematic diagram illustrating an exemplary group chat page for recipient 1, in accordance with an embodiment.

FIG. 23 presents a flowchart illustrating an exemplary process for determining a reply mode of a message, in accordance with an embodiment.

FIG. 24 presents a flowchart illustrating an exemplary process for user selection of all or one communication parties to receive a follow-up reply, in accordance with an embodiment.

FIG. 25 presents a flowchart illustrating an exemplary process for a team-based communication method, in accordance with an embodiment.

FIG. 26 presents a schematic diagram illustrating an exemplary electronic device, in accordance with an embodiment.

FIG. 27 presents a schematic diagram illustrating an exemplary communication device, in accordance with an embodiment.

FIG. 28 presents a schematic diagram illustrating an exemplary communication device, in accordance with an embodiment.

FIG. 29 presents a schematic diagram illustrating an exemplary communication device, in accordance with an embodiment.

FIG. 30 presents a schematic diagram illustrating an exemplary communication device, in accordance with an embodiment.

FIG. 31 presents a schematic diagram illustrating an exemplary mobile communication device, in accordance with an embodiment.

FIG. 32 presents a schematic diagram illustrating an exemplary server for private communication with multiple parties, in accordance with an embodiment.

### DETAILED DESCRIPTION OF EMBODIMENTS

The embodiments described in the present disclosure solve the problem of improving privacy for communication sessions involving multiple parties by allowing for private communications between individual participants when multiple parties are involved in a communication session. A sender that is sending a message to multiple recipients may set a reply mode of the message to private mode. When the reply mode is set to private mode, only communication parties with permission to view replies to the message may receive and view a reply message sent by a recipient.

There are multiple ways to specify the communication parties with permission to view replies to the message. The sender of a message to multiple recipients may specify the recipients to be granted viewing permission. The sender may have viewing permission to receive and view reply messages. A recipient replying to the message may specify other recipients that will receive viewing permission. The recipients that are members of the same team as the sender may each receive viewing permission. Furthermore, other recipients that are members of the same team as a replying recipient may also receive viewing permission.

The message may be a reminder message sent by the sender to the multiple recipients. The sender may specify the reply mode when creating the reminder message.

Some embodiments also allow the sender to configure a group, and group members may participate in a group chat. For example, the sender may configure the group as a private group which results in messages being sent to the group being set to private mode. In some embodiments, the system may set messages to private mode in response to determining that the sender and the multiple recipients are not on the same team. The system may set the messages to private mode or public mode based on user input in scenarios where the sender and the multiple recipients are on the same team.

A communication server that provides services for communication sessions may receive a follow-up reply from a sender that is responsive to a reply message from a recipient. The sender may also select recipients for the follow-up reply. The server may then send the follow-up reply to the selected recipients.

Exemplary Computing System for Private Communication with Multiple Parties

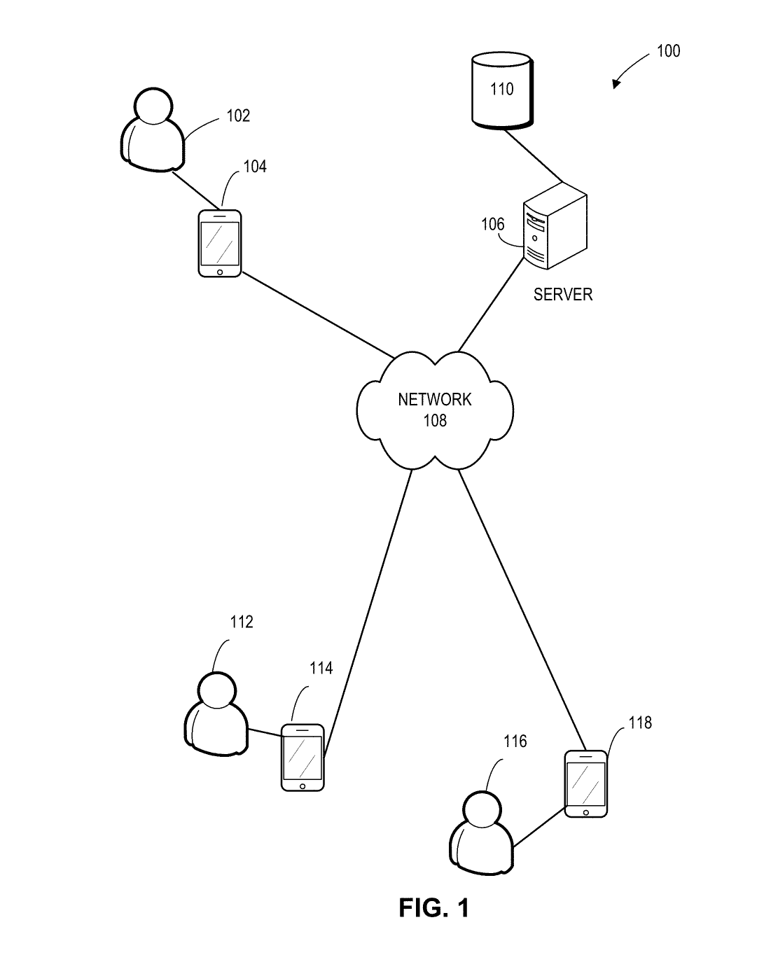

FIG. 1 presents a diagram illustrating an exemplary computing system 100 for private communication with multiple parties, in accordance with an embodiment. As illustrated in FIG. 1, a user 102 may be operating an electronic device 104 with installed modules that allows user 102 to participate in instant messaging, view Internet webpages, initiate voice/video phone calls, share files, and receive e-mails. User 102 may also operate electronic device 104 during group communications. Electronic device 104 may be a mobile device such as a mobile phone, a tablet, a laptop, a desktop computer, or any other type of computing device. User 102 may represent, for example, a user associated with an organization. Electronic device 104 may communicate with a server 106 over a network 108. Server 106 may represent a server that performs operations associated with private communication with multiple parties. For example, the server may receive a message, determine one or more parties with viewing permission to receive corresponding reply messages, and send the reply messages only to the parties with viewing permission. Server 106 may include a storage 110 for storing code for various applications and other data, such as code for instant messaging software (including modules that facilitate private communication with multiple parties) and user and message data. Storage 110 may also store code for the modules described herein, such as an identifying module which may identify, among a sender and multiple recipients, a communication party with permission to view a reply message. Note that server 106 may represent a cluster of machines supporting private communication with multiple parties.

User 112 may operate a client device 114, and user 116 may operate a client device 118. For example, user 112 may operate client device 114 to connect to server 106 and receive messages sent by user 116. User 112 can also use client device 114 to conduct instant messaging with other parties, such as user 102. Note that each of client devices 114, 116 may be a mobile device such as a mobile phone, a tablet, a laptop, a desktop computer, or any other type of computing device.

In some embodiments, a client can send a request for customized executable code that when installed allows for instant messaging and/or private communication with multiple parties and/or interacting with server 106. The client can receive the executable code from server 106 and then install the executable code to enable instant messaging and/or private communication with multiple parties. Server 106 can automatically update the executable code. Furthermore, an application and/or operating system executing on a client may also load modules and/or other data into memory only when needed, in order to efficiently utilize memory space. The client may also encrypt communications, such as the messages, when the communications are sent across the network. This prevents eavesdropping by third parties not authorized to view the communications.

Note that the techniques discussed in the present disclosure represent an improvement in various technology areas such as human-machine interaction, user interfaces, and digital communications. In particular, the disclosed embodiments improve communication privacy and security. Existing technologies cannot allow participants in a communication session to specify privacy requirements for their communications according to the needs of different scenarios.

### Exemplary Process for Communication

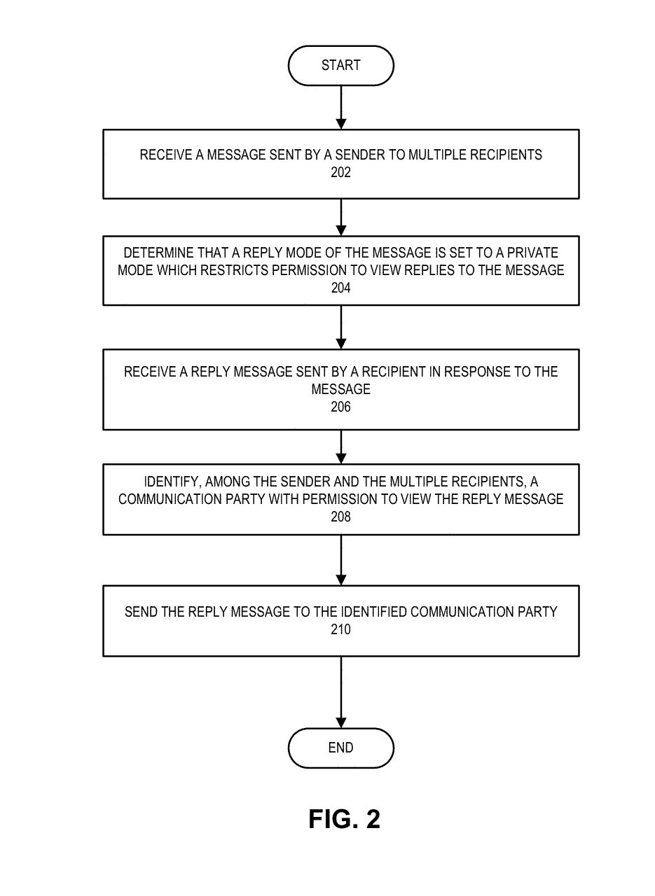

FIG. 2 presents a flowchart illustrating an exemplary process for private communication with multiple parties, in accordance with an embodiment. A server may perform the operations of FIG. 2, and the operations are described in detail below.

The system may receive a message sent by a sender to multiple recipients (operation 202). The system may then determine that a reply mode of the message is set to a private mode which restricts permission to view replies to the message (operation 204). The system may receive a reply message sent by a recipient in response to the message (operation 206). The system may identify, among the sender and the multiple recipients, a communication party with permission to view the reply message (operation 208). The system may then send the reply message to the identified communication party (operation 210). These operations are described in greater detail below.

The system may receive a message sent by a sender to multiple recipients (operation 202). The message may be of any type. For example, the message may be an instant message, which may be generated and transmitted/received by a DingTalk client, an Enterprise Instant Messaging (EIM) application, and the server accessed by the application may be a corresponding DingTalk server.

In some embodiments, the message content may include at least one of text, pictures, multimedia data (e.g., audio and/or video), and files (e.g., documents, tables).

In an embodiment, a message may be a reminder message sent by a sender to multiple recipients. For example, the reminder message may be a DING message supported by a DingTalk client when the sender sends the reminder message through the DingTalk client.

The system may then determine that a reply mode of the message is set to a private mode which restricts permission to view replies to the message (operation 204). The sender's computing device may display a control for a message configuration option on a reminder message creation page. The sender may operate the control to set a reply mode of the reminder message. For example, the sender may set the reminder message to one of a private mode or a non-private mode.

A sender and multiple recipients may be members of the same group. The message may be a group message sent by the sender to the group. In one scenario, the sender may separately set a corresponding reply mode for each group message. In another scenario, an administration page for the group may include a control for a group configuration option. The sender may use the control for the group configuration option to configure the group (e.g., the sender sets or changes the group configuration option). If the group is set as a private group, the system sets all messages sent to the private group to private mode by default. The sender does not need to set each of the messages manually.

The system may receive a reply message sent by a recipient in response to the message (operation 206).

The system may identify, among the sender and the multiple recipients, a communication party with permission to view the reply message (operation 208).

In some embodiments, the sender may grant permission to view reply messages to a set of communication parties when the sender sends a message. That is, the sender may select which communication parties are to be granted viewing permission. Alternatively, the recipient may specify the communication parties to be granted permission to view reply messages when the recipient sends the reply message. In some embodiments, the system may specify a default communication party with permission to view reply messages for a communication application, and there is no need for the sender or recipients to actively configure the viewing permissions. Some embodiments may also include other techniques to determine the communication parties with viewing permission, and the various embodiments are not limited to the techniques described herein.

The system may select the communication parties with the viewing permission that receive the reply message from among the sender and multiple recipients. In some embodiments, the communication parties with viewing permission may include at least one of a sender, a recipient specified by the sender, another recipient specified by any recipient, a recipient that is a member of the same team as the sender, and a recipient that is a member of a team to which any recipient belongs.

The system may then send the reply message to the identified communication party (operation 210).

If the system receives a follow-up reply from the sender that is responsive to a reply message from a recipient, and if the sender selects one or more reply recipients (e.g., users that are to receive the follow-up reply) from among multiple recipients, the system may send the follow-up reply to the selected reply recipients. The sender may implement various forms of message replies (e.g., the reply recipients may be all recipients, or be at least one designated recipient) by designating the reply recipients without changing the communication session page. This contributes to improving communication efficiency, which includes improving the effectiveness and ease-of-use of a user interface.

By configuring a message to private mode so that only communication parties with viewing permission can receive and view corresponding reply messages, the information security of the reply messages may be guaranteed. Also, in some embodiments, the communication parties with viewing permission may receive and view all reply messages sent by other communication parties on a reply page for the message. There is no need to separately create independent communication sessions with the other communication parties.

### Exemplary Process for Messaging Communication Method

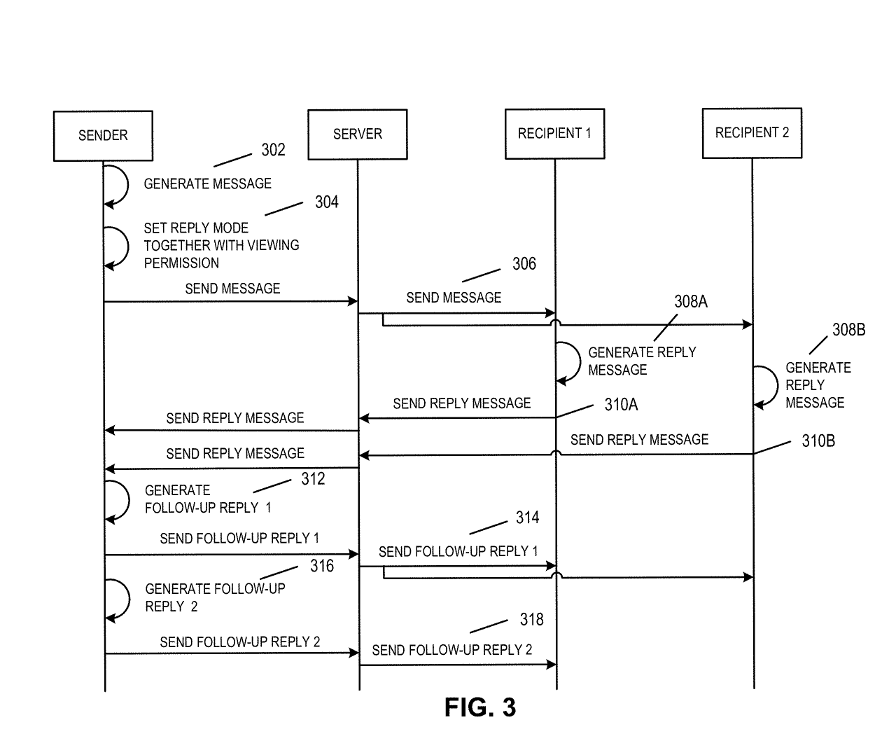

FIG. 3 presents a flowchart illustrating an exemplary process for a messaging communication method, in accordance with an embodiment. In the scenario illustrated in FIG. 3, DingTalk clients are installed on all communication devices used by a sender, a recipient 1, and a recipient 2. The DingTalk server software is configured on a server, so that the sender may communicate with recipient 1 and recipient 2 through the server. The method may include the operations described below.

The sender may generate a message (operation 302). The sender may set a reply mode and viewing permission for the message (operation 304). The sender may then send the message to a server, and the server may send the message to recipient 1 and recipient 2 separately (operation 306).

Recipient 1 may generate the reply message (operation 308A). Recipient 1 may then send the reply message to the server, and the server may send the reply message to the sender (operation 310A).

Recipient 2 may generate the reply message (operation 308B). Recipient 2 may send the reply message to the server, and the server may send the reply message to the sender (operation 310B).

The sender may subsequently generate a follow-up reply 1 (operation 312). The sender may send follow-up reply 1 to the server, and the server may send follow-up reply 1 to recipient 1 and recipient 2 (operation 314). The sender may generate a follow-up reply 2 (operation 316). The sender may send follow-up reply 2 to the server, and the server may send follow-up reply 2 to recipient 1 (operation 318). These operations are described in greater detail below.

The sender may generate the message (operation 302).

### Exemplary Reminder Message Creation Page

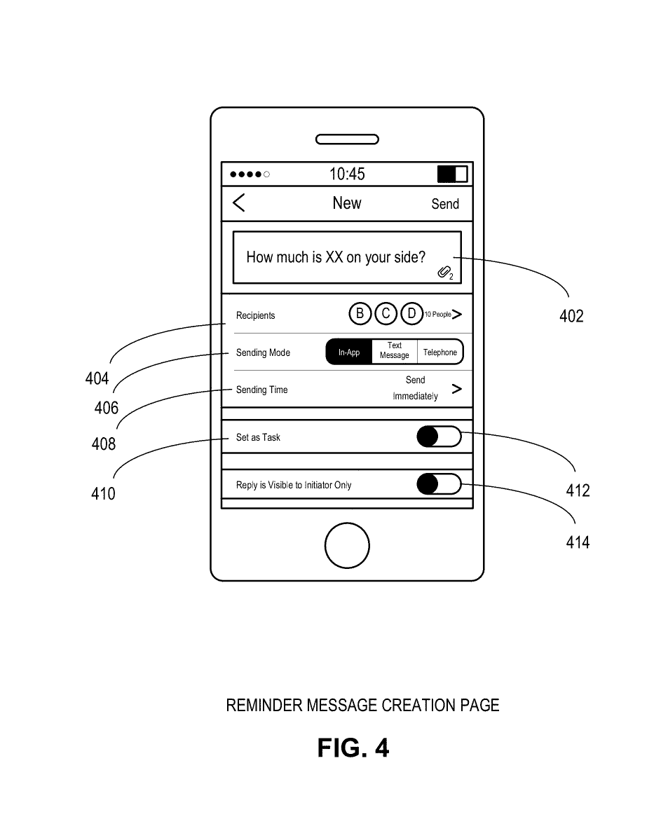

FIG. 4 presents a schematic diagram illustrating an exemplary reminder message creation page, in accordance with an embodiment. The disclosure below describes reminder messages but the description may also be applicable to other messages.

In some embodiments, DingTalk may provide a reminder message creation page as illustrated in FIG. 4 for the sender to create a reminder message. The reminder message may be a DING message. As illustrated in FIG. 4, the reminder message creation page may include multiple sections. The system may display an input box 402 on the top of the page. Within input box 402, the system may display the message content “How much is XX on your side?” as input by a user. The user may specify the recipients of the reminder message through a “Recipients” selection control 404 on the page. For example, 10 users (e.g., including user B, user C, and user D) are selected as recipients in FIG. 4.

The user may select a sending mode for the reminder message by using a control for a “Sending Mode” option 406 on the page. For example, if the user selects “In-App,” the system only sends reminder messages in the form of instant messaging to the recipients. If the user selects “Text Message,” the system may send reminder messages in the form of instant messaging and text messages to the recipients to increase reminder intensity. If the user selects “Telephone,” the system may send reminder messages in the form of instant messaging to the recipients, and the system may issue telephone calls to the recipients together with voice broadcast of the message content of the reminder message, thereby further improving the reminder intensity.

The user may select a sending time for the reminder message by configuring a “Sending Time” option 408 on the page. For example, the user may choose to send immediately, send half an hour later, or send at a designated time. If the user activates a “Set as Task” option 410 (e.g., by sliding a virtual switch control 412 to the right in FIG. 4) the reminder message will be associated with a task property. That is, the reminder message has a corresponding task completion deadline, and the recipients must provide task completion status information back to the sender prior to the task completion deadline. Note that there may also be other options available on the page for the sender to select and configure.

The sender may set a reply mode and viewing permission for the message (operation 304).

With existing systems the reply mode of messages generated by the sender are typically all set to non-private mode. That is, all communication parties (e.g., the sender and all recipients) associated with the messages may receive and view the reply messages of each communication party for the messages.

However, in some cases, the sender may not want the recipients to view each other's reply messages. For example, in one scenario the sender may be an enterprise procurement staff member, and recipient 1 and recipient 2 may be salespeople associated with different distributors. The sender may issue reminder messages to recipient 1 and recipient 2 to inquire of the same goods from the two distributors. When set to the non-private mode, the reply message sent by recipient 1 to the sender may be viewed by recipient 2 and other recipients. Likewise, the reply message sent by recipient 2 to the sender may be viewed by recipient 1 and other recipients. However, recipient 1 and recipient 2 may not desire to have their quotations viewed by each other. Furthermore, the sender may not want the distributors to have excessive contacts with each other, so the sender has no choice but to communicate with each recipient through a separate communication page.

As an example, the sender should be able to send one message to ten recipients, but for information confidentiality reasons the sender must separately send 10 messages to 10 recipients separately. Further, if the recipients return reply messages, the sender must repeatedly switch between 10 communication session pages. In more complex scenarios, the sender might need to communicate with more recipients, so the sender's operations become increasingly complex, and the communication efficiency is relatively low.

Therefore, the system may provide a control for a “Reply is Visible to Initiator Only” option 414 on a message creation page as illustrated in FIG. 4. The control (e.g., a virtual switch) for this option may be located on the display as illustrated in FIG. 4. The control for the option is depicted in an inactivated state, but the sender may activate the control for the option by sliding the control to the right side, thereby setting the reply mode of the message to private mode. Then, if a recipient sends a reply message for the message, only communication parties with viewing permission may review the reply message. Moreover, based on the state of the control for “Reply is Visible to Initiator Only” option 414, the communication parties with viewing permission may include only the sender (e.g., “initiator”).

### Exemplary Reminder Message Creation Page

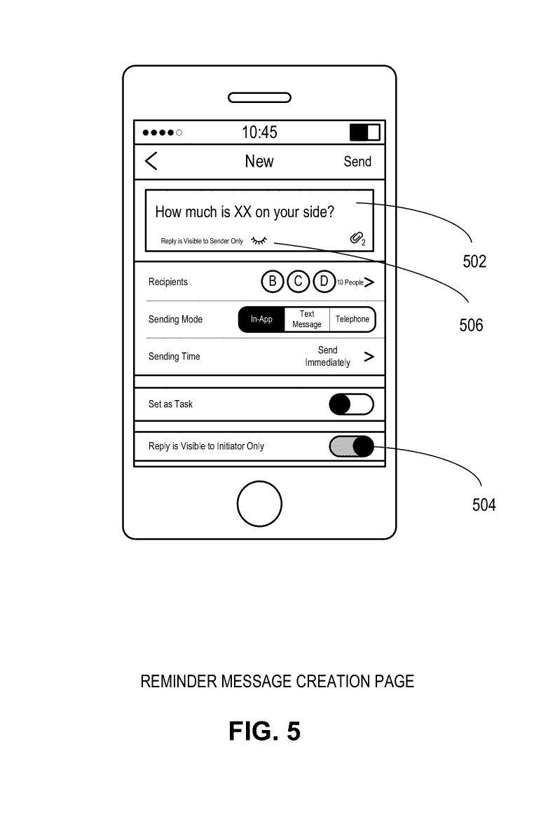

FIG. 5 presents a schematic diagram illustrating an exemplary reminder message creation page, in accordance with an embodiment. The system may display mode identification information for a reply mode corresponding to a message in an input box 502. For example, the system may indicate that the message is set to private mode if a control for a “Reply is Visible to Initiator Only” option 504 is activated. The system may display a closed eye icon 506 (e.g., located below “How much is XX on your side?” text, and to the right side of “Reply is Visible to Sender Only” text in the input box) as illustrated in FIG. 5.

The system may also indicate the communication parties with permission to view the reply messages in the input box. For example, if the communication parties with viewing permission include only the sender, as illustrated in FIG. 5, the system may display indicative text such as “Reply is Visible to Sender Only” in input box 502.

Since the sender may configure options such as “Reply is Visible to Initiator Only,” and the system displays the mode identification information and indicates the communication parties with viewing permission in the input box, the system allows the user to determine the reply mode for the message in a timely manner. This helps the user to avoid using the wrong reply mode.

The sender may then send the message to a server, and the server may send the message to recipient 1 and recipient 2 separately (operation 306).

### Exemplary Details Pages

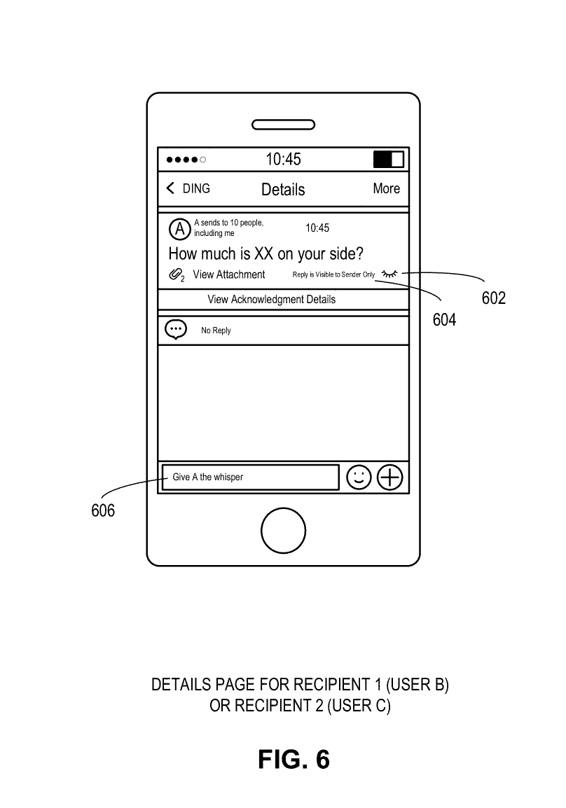

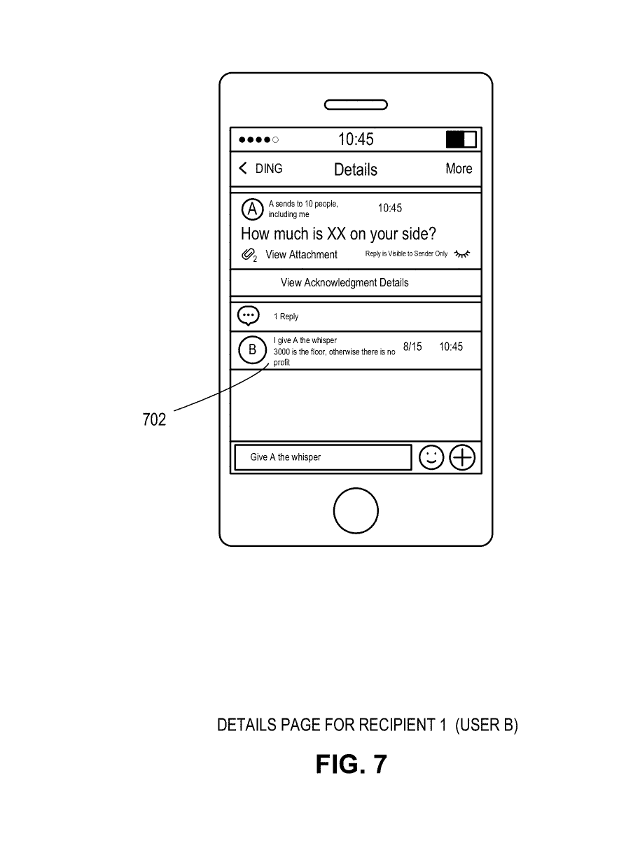

FIG. 6 presents a schematic diagram illustrating an exemplary details page for recipient 1 or recipient 2, in accordance with an embodiment. FIG. 7 presents a schematic diagram illustrating an exemplary details page for recipient 1, in accordance with an embodiment. A details page displays information associated with messages. A user may interact with a details page to view and respond to messages and/or corresponding replies.

Recipient 1 and/or recipient 2 may view the message content of a message from a sender on the details page as illustrated in FIG. 6. As illustrated in FIG. 6, recipient 1 or recipient 2 may view the details page which indicates that the sender of the message is “A” and the message is sent to “10 people, including me.” That is, there are 10 recipients of the message.

In the presentation area of the message illustrated in FIG. 6, the system may display information similar to that illustrated in FIG. 5. For example, the system may display information such as mode identification information for the reply mode corresponding to the message (e.g., a closed eye icon 602). The system may also display information regarding the communication parties with permission to view the reply messages (e.g., “Reply is Visible to Sender Only” text 604). The recipient may thereby readily comprehend the information security situation associated with the message.

Recipient 1 may generate the reply message (operation 308A).

Recipient 1 may use a reply message edit box 606 at the bottom of the details page to generate a reply message. If the reply mode of the message is set to private mode, the system may display in reply message edit box 606 an indication of a peer communication party with viewing permission for the reply message. The peer communication party is a party that a local communication party may send a communication to. The peer communication party may be the sender if a recipient is sending a reply message to the sender. In various scenarios, the local communication party may be a sender of a message or a recipient of a message.

For example, the system may display “Give A the whisper” text 606 in FIG. 6 to indicate that the peer communication party with permission to view the reply message is user A (e.g., the sender). Recipient 1 may thereby understand that only user A will be able to view the reply message, and recipient 1 need not be concerned with the reply message being received and viewed by other users.

Recipient 1 may generate a reply message “3000 is the floor, otherwise there is no profit” using the reply message edit box. After the reply message is sent, the details page for recipient 1 is as illustrated in FIG. 7, in which “I give A the whisper 3000 is the floor, otherwise there is no profit” text 702 may be viewed.

Recipient 1 may send the reply message to the server, and the server may send the reply message to the sender (operation 310A).

### Additional Exemplary Details Pages

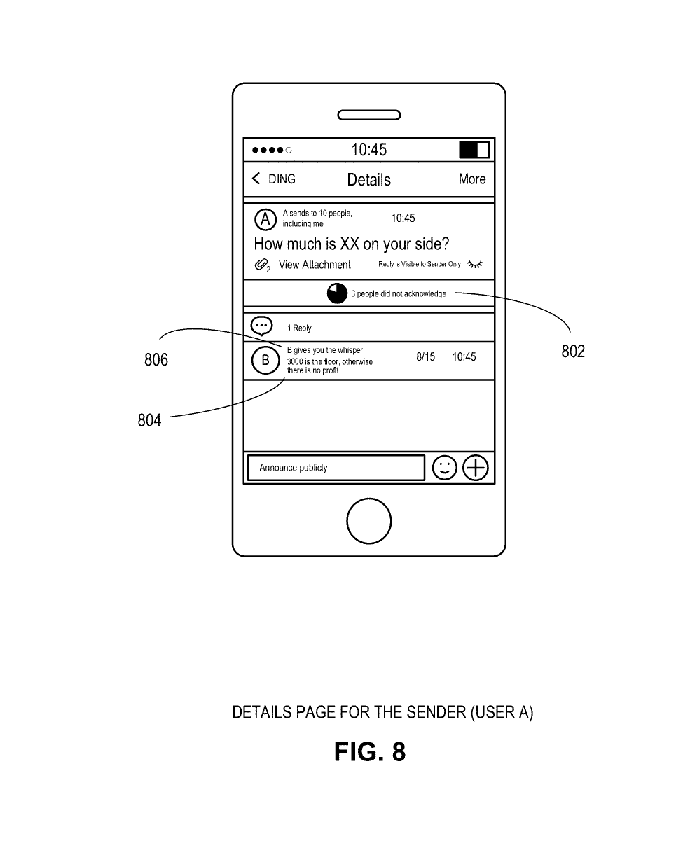

FIG. 8 presents a schematic diagram illustrating an exemplary details page for the sender, in accordance with an embodiment. The system may display the viewing status of each recipient for a message. For example, the system may display “3 people did not acknowledge” text 802 as illustrated in FIG. 8 to indicate that 3 recipients did not view the message, while the other 7 recipients have viewed the message. A recipient may view the details of the viewing status for each recipient by clicking on “3 people did not acknowledge” text 802.

In the details page illustrated in FIG. 8, the system may display the reply message sent by each recipient in response to the message. For example, the system may display “3000 is the floor, otherwise there is no profit” as a reply message 804 sent by user B acting as recipient 1. The reply mode of the message is set to private mode, and the sender is the only user with permission to view the reply message. The system may display “B gives you the whisper” text 806 to indicate that only the sender may receive and view the reply message. Other communication parties (e.g., other recipients such as user C or user D) cannot receive and view the reply message. For example, the details page on a communication device operated by recipient 2 may be as illustrated in FIG. 6, and the system does not display the reply message sent by user B acting as recipient 1.

In other words, since the message sent by the sender is set to private mode, and only the sender has viewing permission for the corresponding reply message, the system may only display the reply message on the details page for the sender. If recipient 1 returns the reply message, recipient 2 and other recipients cannot receive and view the reply message. This represents a substantial improvement to the information security of the reply message.

Recipient 2 may generate the reply message (operation 308B).

Recipient 2 may send the reply message to the server, and the server may send the reply message to the sender (operation 310B).

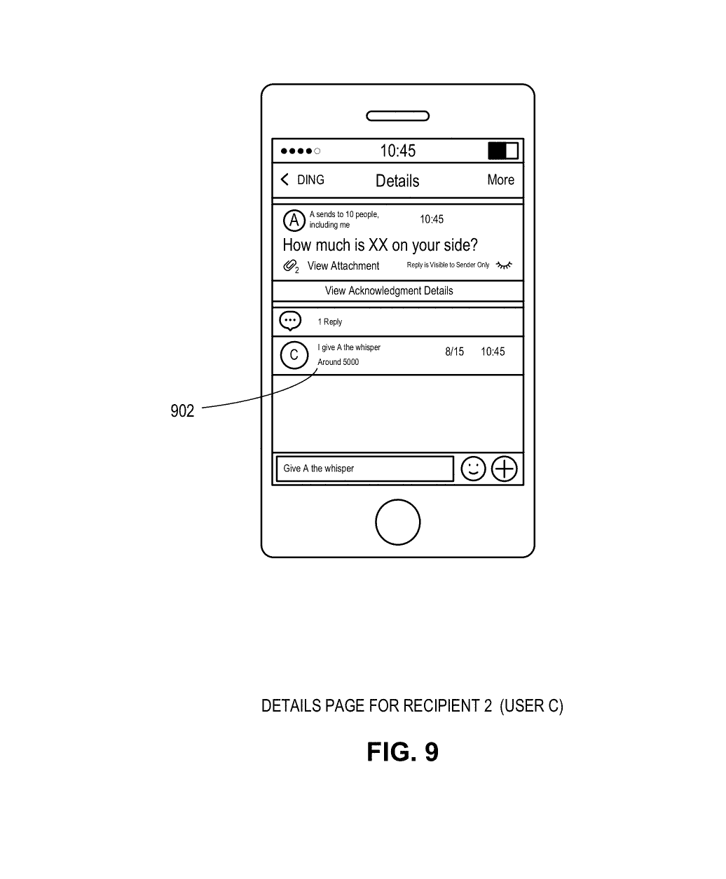

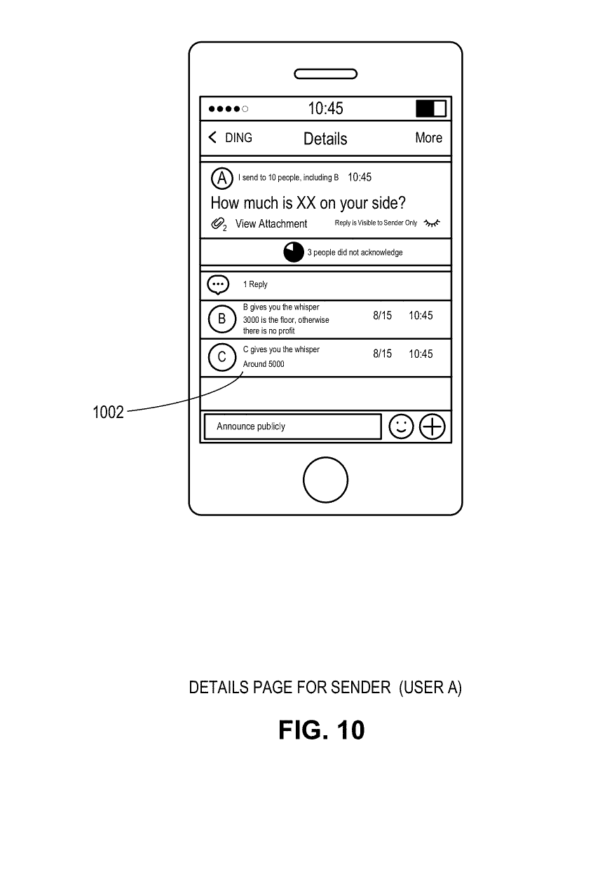

FIG. 9 presents a schematic diagram illustrating an exemplary details page for recipient 2, in accordance with an embodiment. FIG. 10 presents a schematic diagram illustrating an exemplary details page for the sender, in accordance with an embodiment.

Similar to the scenario in which recipient 1 sends the reply message, if recipient 2 returns the reply message “Around 5000” for the message, the system may change the details page of recipient 2 from that illustrated in FIG. 6 to that illustrated in FIG. 9, in which the reply message “Around 5000” sent by recipient 2 is displayed. The system may display the reply message as “Around 5000” text 902. The system may display the reply message on the details page for the sender illustrated in FIG. 10 as “Around 5000” text 1002. However, for recipient 1, the corresponding details page remains the same as that illustrated in FIG. 7 without displaying the reply message sent by recipient 2.

The sender may generate a follow-up reply 1 (operation 312).

The sender may send follow-up reply 1 to the server, and the server may send follow-up reply 1 to recipient 1 and recipient 2 (operation 314).

When responding to the reply message described above, the message sent by the sender is described as a “follow-up reply” (e.g., follow-up reply 1, follow-up reply 2) in order to differentiate from the “reply message” sent by the recipient.

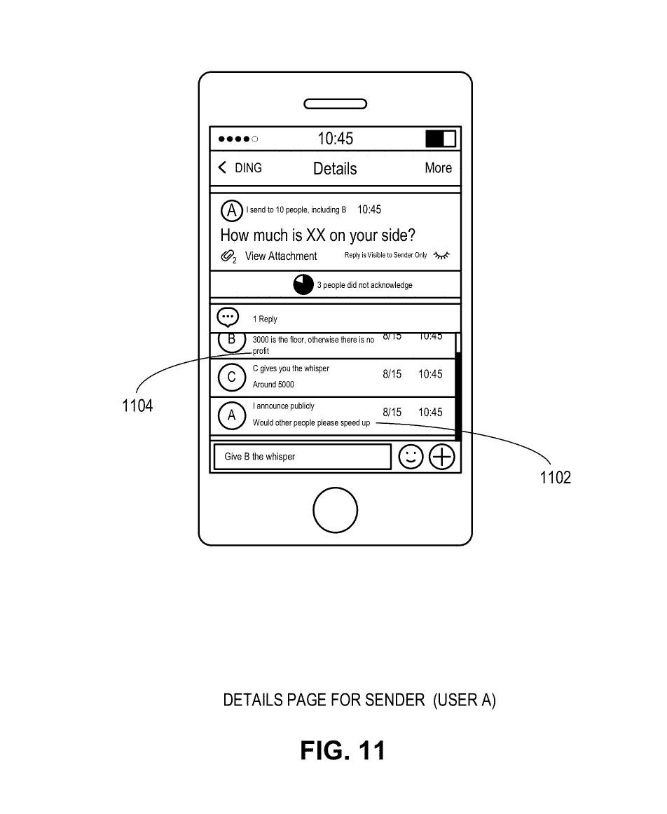

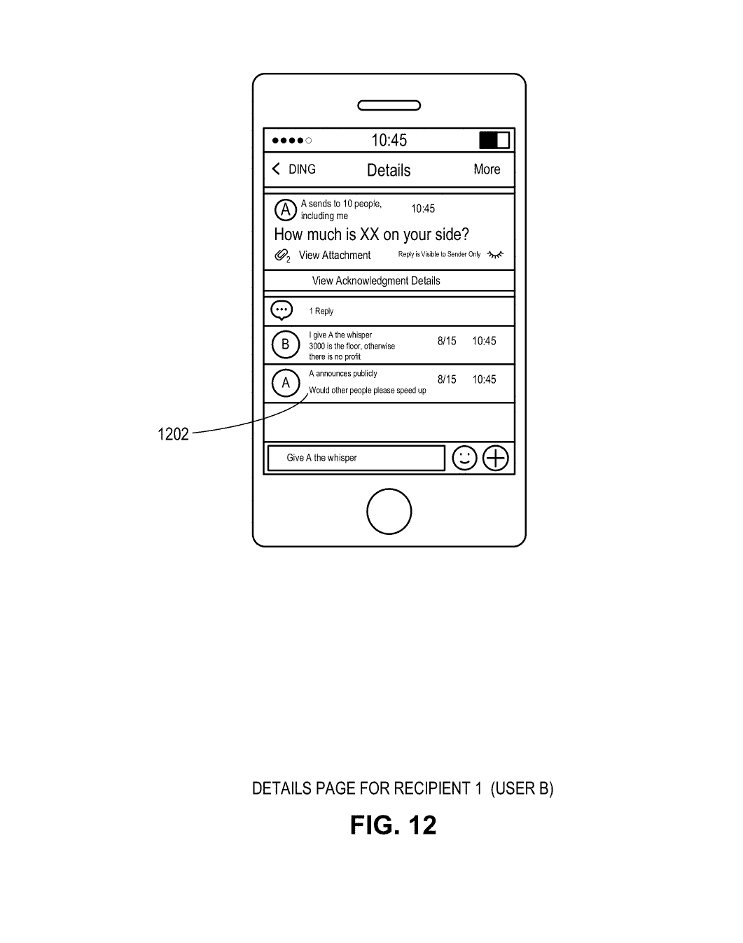

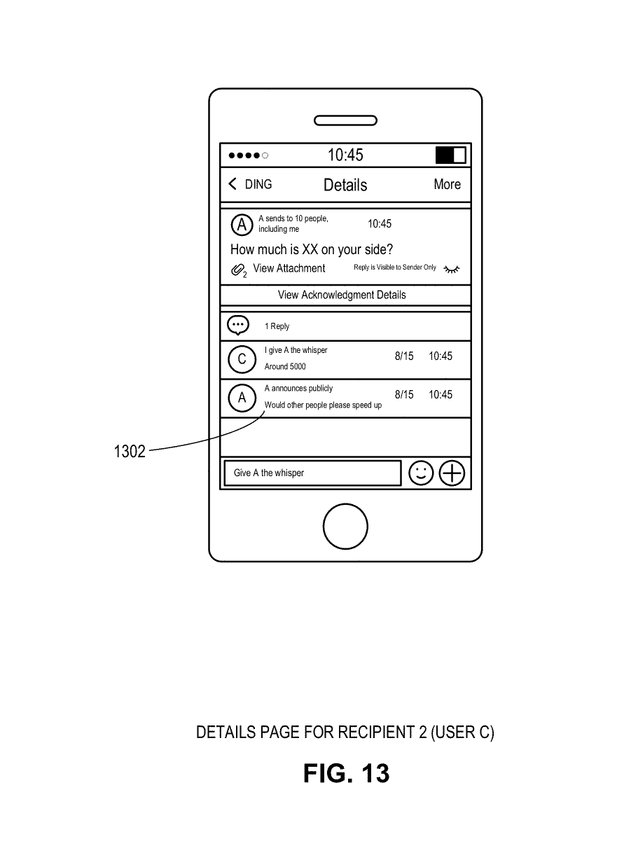

FIG. 11 presents a schematic diagram illustrating an exemplary details page for the sender, in accordance with an embodiment. FIG. 12 presents a schematic diagram illustrating an exemplary details page for recipient 1, in accordance with an embodiment. FIG. 13 presents a schematic diagram illustrating an exemplary details page for recipient 2, in accordance with an embodiment

In some embodiments, on the details page for the sender for the message described above, the system may indicate communication parties with permission to view follow-up reply 1 in the reply message edit box at the bottom of the page. For example, in a default scenario, as illustrated in FIG. 8 or FIG. 10, the system may indicate that the communication parties with viewing permission include all recipients by displaying “Announce publicly” in the reply message edit box. If the sender sends follow-up reply 1, the server may send follow-up reply 1 “Would other people please speed up” to the communication parties with viewing permission, which may include all recipients described above, such as recipient 1 and recipient 2. The system may then change the details page for the sender to that illustrated in FIG. 11. FIG. 11 depicts follow-up reply 1 as “Would other people please speed up” text 1102, as well as other messages received, such as “3000 is the floor, otherwise there is no profit” text 1104. The system may change the details page for recipient 1 to that illustrated in FIG. 12, which displays “Would other people please speed up” text 1202. The system may also change the details page for recipient 2 to that illustrated in FIG. 13, which displays “Would other people please speed up” text 1302.

The sender may generate a follow-up reply 2 (operation 316).

The sender may send follow-up reply 2 to the server, and the server may send follow-up reply 2 to recipient 1 (operation 318).

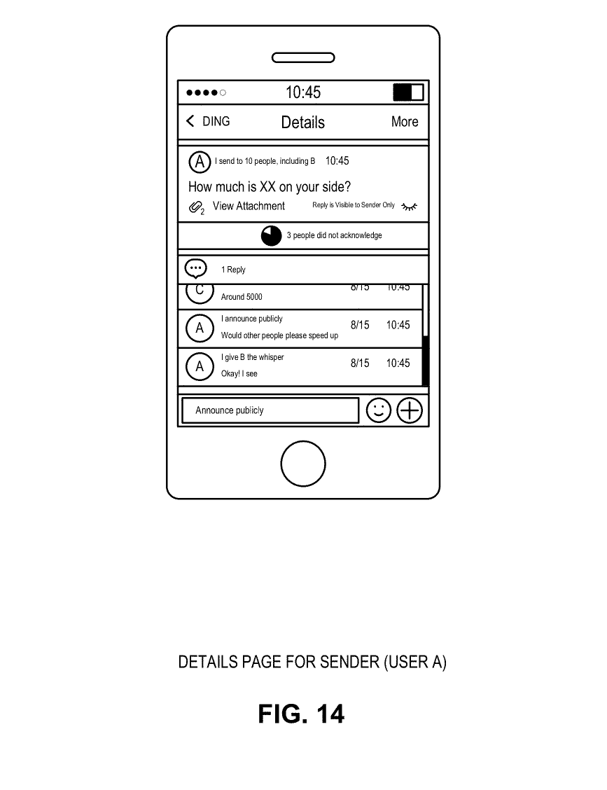

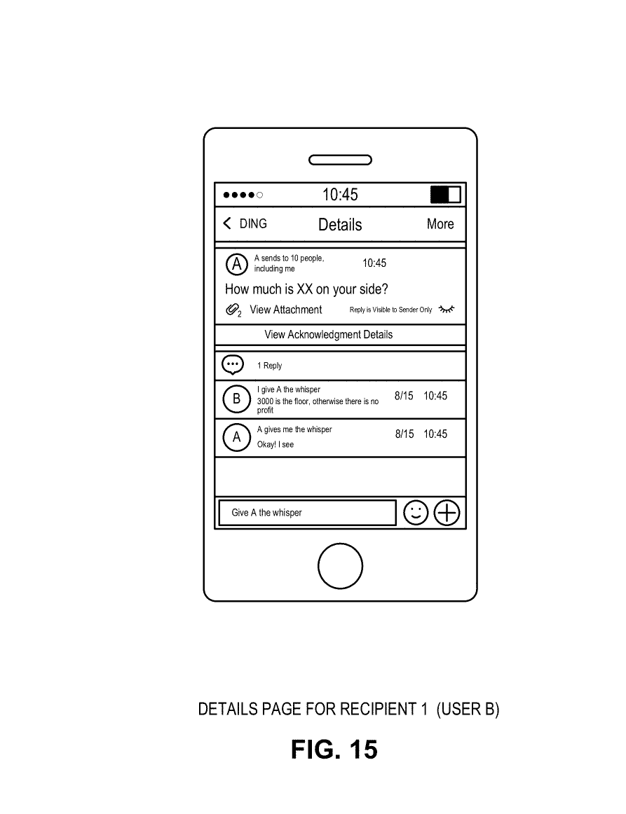

FIG. 14 presents a schematic diagram illustrating an exemplary details page for the sender, in accordance with an embodiment. FIG. 15 presents a schematic diagram illustrating an exemplary details page for recipient 1, in accordance with an embodiment.

In some embodiments, if the sender clicks on a reply message from a recipient, the system may indicate that the recipient is to be granted viewing permission. For example, if the sender clicks on “3000 is the floor, otherwise there is no profit” text 1104 the system may display “Give B the whisper” as illustrated in FIG. 11 to indicate only user B acting as recipient 1 has viewing permission. If the sender sends follow-up reply 2, the server may send follow-up reply 2 “Okay! I see” to the communication party with the viewing permission, e.g., recipient 1. The system may change the details page for the sender to that illustrated in FIG. 14. The system may change the details page for recipient 1 to that illustrated in FIG. 15. The details page for recipient 2 may remain the same as that illustrated in FIG. 13 without change.

The sender may grant viewing permission to communication parties using a number of techniques. For example, the sender may select the reply message edit box to select all communication parties to receive the viewing permission. The sender may also select any recipient to receive viewing permission by selecting the reply message of the recipient. The sender may grant the viewing permission to the communication parties using other techniques as well. For example, the sender may select communication parties to be granted viewing permission from a pop-up menu.

In addition to the sender, a recipient may also specify the communication parties to be granted permission to view a reply message when the recipient sends the reply message. For example, recipient 1 may grant viewing permission to the sender and recipient 2. The sender and recipient 2 may receive and view the reply message sent by recipient 1, while the other 8 recipients cannot receive and view the reply message.

### Exemplary Process for a Cross-Enterprise Group Communication Method

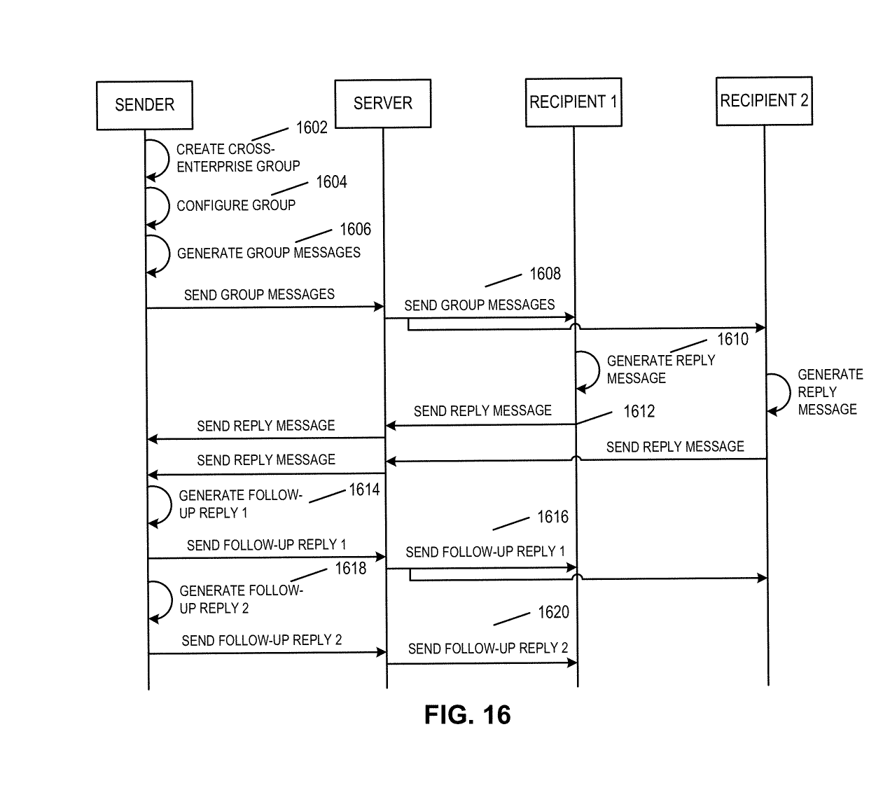

FIG. 16 presents a flowchart illustrating an exemplary process for a cross-enterprise group communication method, in accordance with an embodiment. In the illustrated scenario of FIG. 16, DingTalk clients are installed on all communication devices used by a sender, a recipient 1, and a recipient 2. DingTalk server software may be installed and configured on a server, and the sender may communicate with recipient 1 and recipient 2 through the server. The method may include the operations as described below.

The sender may create a cross-enterprise group (operation 1602). The sender may configure the group (operation 1604). The sender may then generate group messages (operation 1606).

The sender may send group messages through the server to the group members (operation 1608). For example, the group members may be recipient 1 and recipient 2.

Recipient 1 may generate a reply message (operation 1610). Recipient 1 may send the reply message to the sender through the server (operation 1612).

The sender may generate a follow-up reply 1 (operation 1614). The sender may send follow-up reply 1 through the server to recipient 1 and recipient 2 (operation 1616).

The sender may generate a follow-up reply 2 (operation 1618). The sender may send follow-up reply 2 through the server to recipient 1 (operation 1620). These operations are described in greater detail below.

The sender may create a cross-enterprise group (operation 1602).

If the sender creates a cross-enterprise group through the server, the cross-enterprise group may include the sender and other group members who have the same team membership information as the sender. The cross-enterprise group may also include group members who have team membership information different from that of the sender. For example, if the sender is a member of a team AA, if a group member that is a member of team AA is also in the cross-enterprise group, the system may determine that the group member and the sender have the same team membership information. Furthermore, if group members belonging to a team BB are in the cross-enterprise group, and the cross-enterprise group also includes group members that are not a member of any team, the system may determine that these group members and the sender have different team membership information. The teams may be formed in various types of organizations, including organizations such as a business enterprise, a school, a government agency, or a police force. The embodiments disclose herein are not limited to any particular types of organizations.

Thus, the “cross-team” aspect serves to “cross” both the inside and outside of team AA. This provides good communication through the cross-enterprise group between the internal members of team AA and the people outside of team AA, and improves communication efficiency as well as reduces communication cost. However, for group members not belonging to team AA in the cross-enterprise group (e.g., these group members may come from suppliers of team AA), the team members of team AA may not want these suppliers to gain knowledge of each other's prices, supply quantities, and other information. In such a scenario, the group communication technique disclosed herein may guarantee information security between the group members.

The techniques disclose herein are applicable to intra-team groups as well. For example, multiple departments within a team may communicate with each other through the group, which also improves information security within the enterprise.

The sender may configure the group (operation 1604).

### Exemplary Group Setup Page

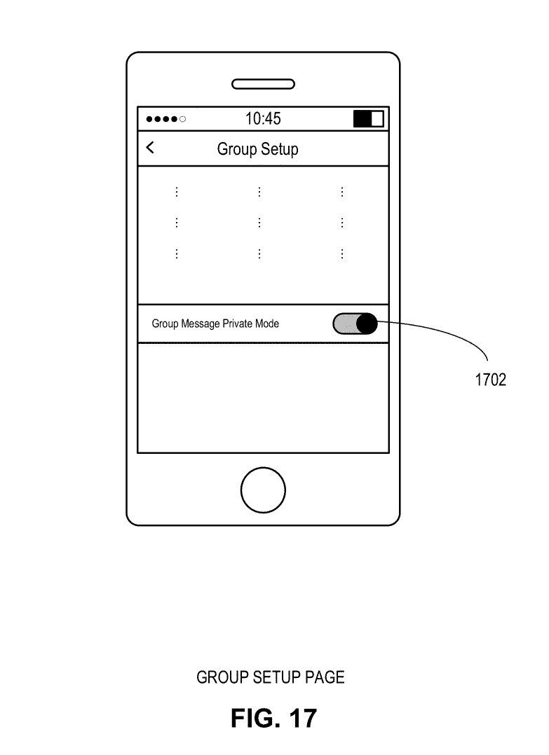

FIG. 17 presents a schematic diagram illustrating an exemplary group setup page, in accordance with an embodiment. The sender may set up the group on a group setup page as illustrated in FIG. 17. For example, the system may provide a control for a “Group Message Private Mode” group configuration option 1702 as illustrated in FIG. 17 on the group setup page. If the sender slides the control (e.g., a virtual switch) for the option to the right side, the group is set as a private group, so that all messages sent to the private group are set to private mode. Otherwise, the group is set as a public group and messages sent to the group are set to public mode.

In a cross-team scenario, with the private mode setting, if a creator of the group acts as the sender, if the sender sends a message to other group members, then a group member acting as a recipient may return a reply message. In some scenarios, only the sender can receive and view the reply message, and other recipients may not receive and view the reply message.

The sender may generate group messages (operation 1606).

The sender may send group messages through the server to the group members (operation 1608). For example, the group members may be recipient 1 and recipient 2.

### Exemplary Group Chat Page

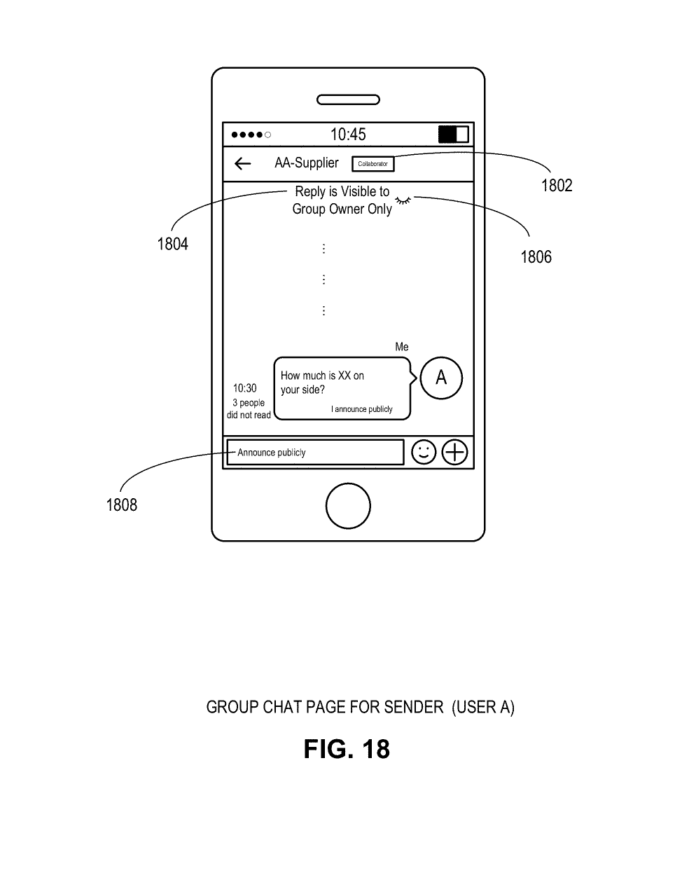

FIG. 18 presents a schematic diagram illustrating an exemplary group chat page for the sender, in accordance with an embodiment. In one scenario, the sender may send group messages to group members (e.g., such as user B acting as recipient 1, and user C acting as recipient 2) through a group chat page as illustrated in FIG. 18. As depicted in FIG. 18, if a group is named “AA-Supplier,” the system may display a group type tag (e.g., “collaborator”) 1802 near the group name to indicate that the group is a cross-enterprise group. Also, if the group is set as a private group, the system may display “Reply is Visible to Group Owner Only” text 1804 in a message presentation area on the group chat page to indicate that only the group owner, e.g., the creator of the group, has permission to view the reply message. For example, the creator may be user A acting as the sender. Moreover, the system may also display a closed eye icon 1806 in the message presentation area to indicate that all reply modes of the group messages sent by the group are set to private mode.

The system may indicate recipients of input content being edited in a reply message edit box 1808 on the group chat page. For example, when the system displays “Announce publicly,” this indicates that all group members will receive and view the message. For example, the content of the message may be “How much is XX on your side?”

Recipient 1 may generate the reply message (operation 1610).

Recipient 1 may send the reply message to the sender through the server (operation 1612).

### Exemplary Group Chat Page

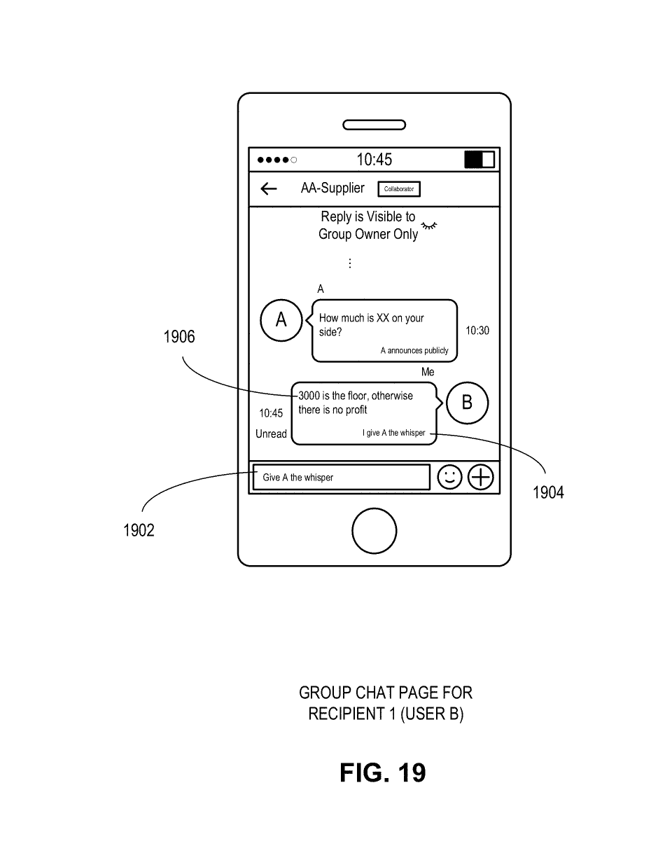

FIG. 19 presents a schematic diagram illustrating an exemplary group chat page for recipient 1, in accordance with an embodiment. As illustrated in FIG. 19, recipient 1 may create the reply message through a reply message edit box 1902 at the bottom of the group chat page. If the reply mode of the message is set to private mode, the system may display an indication of a peer communication party with permission to view the reply message in reply message edit box 1902. For example, the system may display “Give A the whisper” as depicted in FIG. 19 to show that the peer communication party with permission to view the reply message is user A (e.g., user A is the sender and the group owner). Recipient 1 may thereby understand that only user A will receive the reply message, and recipient 1 need not be concerned about others receiving and viewing the reply message. As an example, the reply message created by recipient 1 using reply message edit box 1902 may be “3000 is the floor, otherwise there is no profit.” After sending the reply message, the system may display the group chat page for recipient 1 as illustrated in FIG. 19. As depicted in FIG. 19, recipient 1 may view “I give A the whisper” text 1904 and may also view “3000 is the floor, otherwise there is no profit” text 1906.

Similar to the scenario in which recipient 1 sends a reply message, recipient 2 may also return a reply message directed to the message to the sender. For example, the reply message may be “Around 5000.”

### Exemplary Group Chat Page

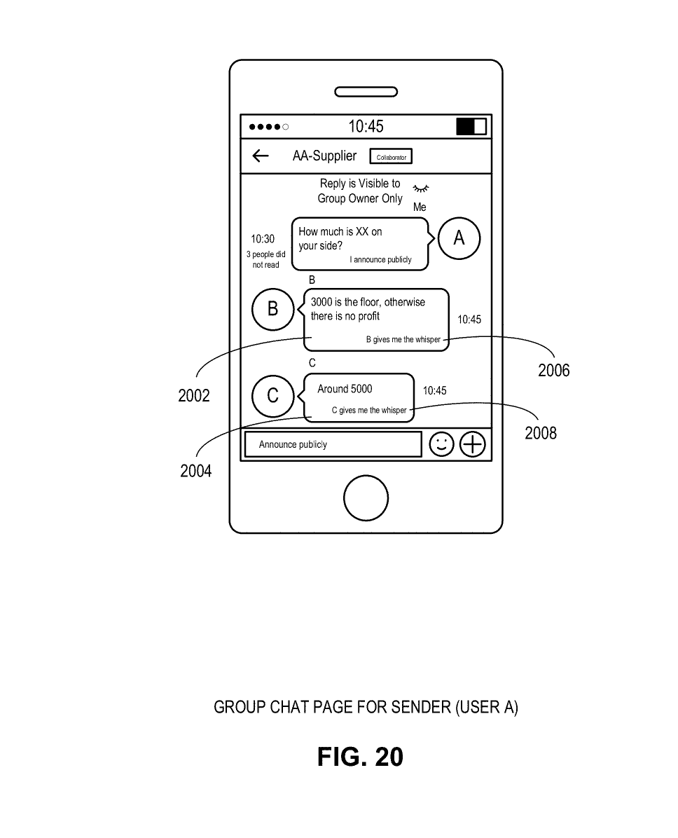

FIG. 20 presents a schematic diagram illustrating an exemplary group chat page for the sender, in accordance with an embodiment. On the group chat page for user A as illustrated in FIG. 20, the system may display the reply messages sent by various recipients, such as recipient 1 and recipient 2, in response to a group message. For example, the system may display “3000 is the floor, otherwise there is no profit” as a reply message 2002 sent by user B acting as recipient 1. The system may also display “Around 5000” as a reply message 2004 sent by user C acting as recipient 2. The reply mode of the message may be set to private mode, and the sender may be the only user with permission to view the reply messages corresponding to the message. The system may display “B gives me the whisper” text 2006 and may also display “C gives me the whisper” text 2008 to indicate that only the sender may receive and view the reply messages. Other communication parties (e.g., such as user C and user D) cannot receive and view the reply messages. For example, the reply message “Around 5000” sent by recipient 2 will not be received and displayed on the group chat page corresponding to recipient 1 illustrated in FIG. 19.

The sender may generate a follow-up reply 1 (operation 1614).

The sender may send follow-up reply 1 through the server to recipient 1 and recipient 2 (operation 1616).

The system may by default display “Announce publicly” in the reply message edit box on the group chat page for the sender, as illustrated in FIG. 20. If the sender inputs and sends follow-up reply 1, the system will send follow-up reply 1 to all group members, including recipient 1 and recipient 2.

The sender may generate a follow-up reply 2 (operation 1618).

The sender may send follow-up reply 2 through the server to recipient 1 (operation 1620).

### Exemplary Group Chat Pages

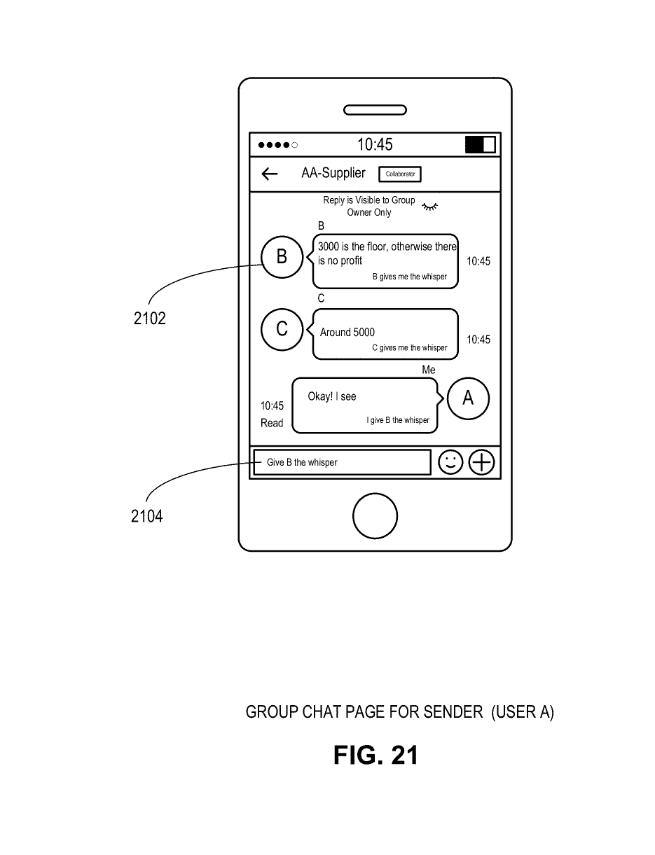

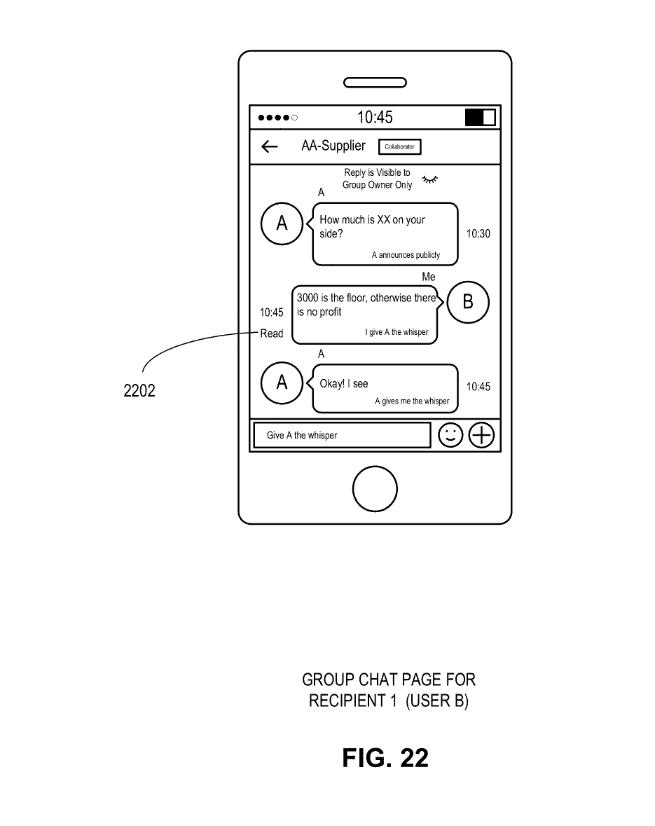

FIG. 21 presents a schematic diagram illustrating an exemplary group chat page for the sender, in accordance with an embodiment. FIG. 22 presents a schematic diagram illustrating an exemplary group chat page for recipient 1, in accordance with an embodiment.

The sender may select recipient 1 to send follow-up reply 2 to recipient 1 only. For example, the sender may press and hold a profile picture of user B 2102 acting as recipient 1. The system may then display the text “Give B the whisper” in a reply message edit box 2104 on the group chat page illustrated in FIG. 21. If the sender inputs and sends follow-up reply 2, the system will send follow-up reply 2 to recipient 1 only, and the system may display follow-up reply 2 (e.g., “Okay! I see”) on the group chat page for recipient 1 as illustrated in FIG. 22. Other group members, such as recipient 2, cannot receive and view follow-up reply 2. The sender may privately communicate with recipient 1 on the group chat page directly without switching to a sidebar page with recipient 1. This simplifies operation for the sender, and improves communication efficiency.

In some embodiments, in a team scenario, the communication parties with viewing permission may include a sender and a recipient that is on the same team as the sender. For example, a group owner A may send a group message to a group member B, a group member C, and a group member D. In this scenario, group owner A and group member B are both members of the same enterprise, but group member C is a member of another enterprise, and group member D is not a member of an enterprise. Under these circumstances, group owner A and group member B may view a reply message sent by group member C, but group member D cannot view the reply message sent by the group member C.

In some embodiments, if any recipient returns a reply message in response to receiving a message from the sender, communication parties with viewing permission may include other recipients that are members of the same team as the recipient. For example, group owner A may send a group message to group member B, group member C, and group member D. In this scenario, group owner A is a member of an enterprise AA, group member B and group member C are members of an enterprise BB, and group member D is not a member of an enterprise. Under these circumstances, group owner A and group member B may view a reply message sent by group member C, but group member D cannot view the reply message sent by group member C.

### Exemplary Process for Determining Reply Mode of a Message

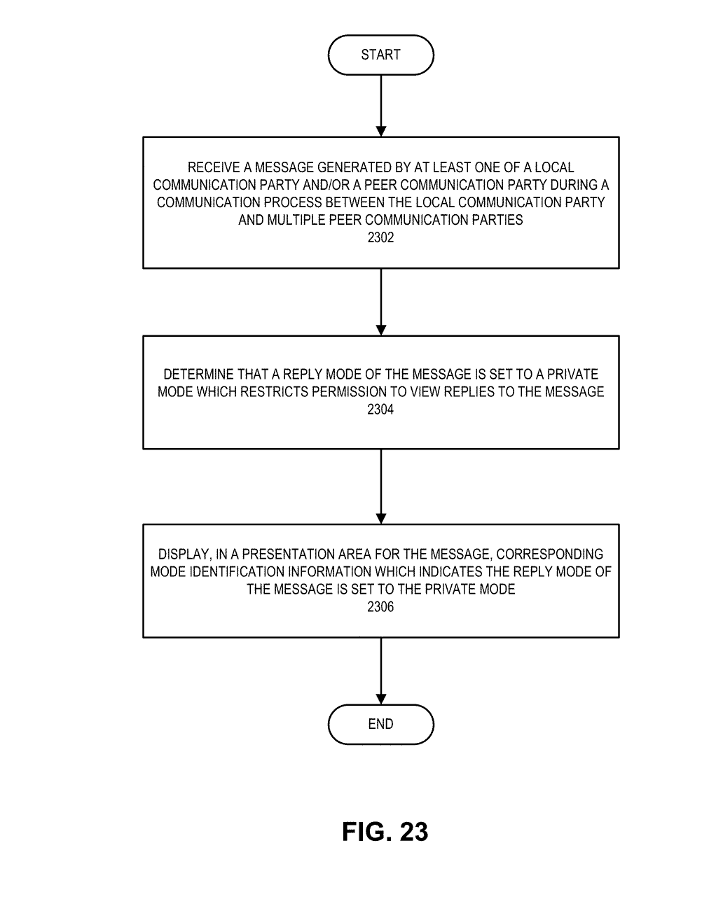

FIG. 23 presents a flowchart illustrating an exemplary process for determining a reply mode of a message, in accordance with an embodiment. Since the system may display messages with different reply modes, the system may perform a process as illustrated in FIG. 23 in order to effectively differentiate between the different reply modes. An electronic device may perform the method illustrated in FIG. 23, and the method may include the operations described below.

The system may receive a message generated by at least one of a local communication party and/or a peer communication party during a communication process between the local communication party and multiple peer communication parties (operation 2302).

The message may be sent by the local communication party. The message may also be sent by any peer communication party and received by the local communication party.

The system may determine that a reply mode of the message is set to a private mode which restricts permission to view replies to the message (operation 2304).

The system may display, in a presentation area for the message, corresponding mode identification information which indicates the reply mode of the message is set to the private mode (operation 2306).

The system may display mode identification information such as the text “Reply is Visible to Sender Only” and the closed eye icon as illustrated in FIG. 7. Since the system displays mode identification information corresponding to a reply mode, the local communication party may easily comprehend a reply mode for the messages, thereby improving communication efficiency.

If the reply mode is a private mode, the system may indicate the peer communication parties with permission to view the associated reply messages in a reply message edit box. For example, if the system displays “Give A the whisper” in the reply message edit box at the bottom of FIG. 7, this indicates that user A is a peer communication party with permission to view the reply messages.

The system may display the viewing status for messages based on the recipients of the messages. In one scenario, as illustrated in FIG. 18, all recipients may receive the messages, and there are a total of 10 recipients. If 7 recipients have read the message, then the system may display “3 people did not read” as illustrated in FIG. 18. If the messages are set to private mode, as illustrated in FIG. 19, if only user A has viewing permission for reply messages from user B, then the system may display only the viewing status of user A (e.g., “Unread”). After user A views the reply messages sent by user B in FIG. 19, the system may display a read status 2202 for the reply messages (e.g., “Read”) as illustrated in FIG. 22. User B need not be concerned with other communication parties that have no viewing permission.

### Exemplary Communication Method

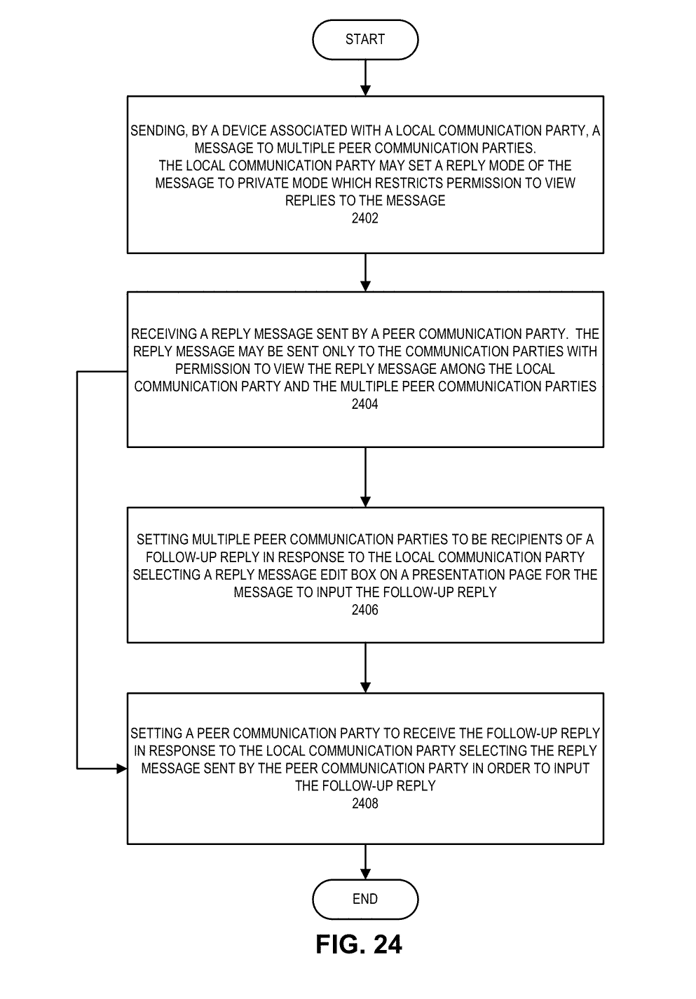

FIG. 24 presents a flowchart illustrating an exemplary process for user selection of all or one communication parties to receive a follow-up reply, in accordance with an embodiment. The illustrated process of FIG. 24 is similar to operations 312-318 of FIG. 3. A local communication party may manually select a public mode or a private mode for sending a follow-up reply according to a reply requirement. An electronic device operated by the local communication party may perform the process of FIG. 24, and the process may include the operations as described below.

The local communication party may operate a device to send a message to multiple peer communication parties. The local communication party may set a reply mode of the message to private mode which restricts permission to view replies to the message (operation 2402).

The system may receive a reply message sent by a peer communication party. The reply message may be sent only to the communication parties with permission to view the reply message among the local communication party and the multiple peer communication parties (operation 2404).

The description of FIG. 2 provides additional details regarding configuring the mode for messages, and the process for replying to messages.

The system may set the multiple peer communication parties to be recipients of a follow-up reply in response to the local communication party selecting a reply message edit box on a presentation page for the message to input the follow-up reply (operation 2406).

For example, as illustrated in FIG. 10, in response to the local communication party performing a clicking operation (or performing some other triggering operation) on the reply message edit box at the bottom of the page, the system may set and display the default mode “Announce publicly.” The system may send the follow-up reply to all of the multiple peer communication parties. By using the corresponding pages illustrated in FIG. 12 and FIG. 13, user B and user C may all view the follow-up reply “Would other people please speed up” sent by user A acting as the local communication party.

The system may set a peer communication party to receive the follow-up reply in response to the local communication party selecting the reply message sent by the peer communication party in order to input the follow-up reply (operation 2408).

For example, the local communication party may click on the text “3000 is the floor, otherwise there is no profit” from user B (a peer communication party) as illustrated in FIG. 10. The system may then display “Give B the whisper” in the reply message edit box at the bottom of the page as illustrated in FIG. 11. This indicates that if the local communication party inputs the follow-up reply at this time, the system will send the follow-up reply only to user B acting as the peer communication party. That is, only user B has viewing permission for the follow-up reply. If the local communication party sends the follow-up reply (e.g., “Okay! I see”) the server may send the follow-up reply to the only user with viewing permission, which is user B. User B may view the follow-up reply on a details page as illustrated in FIG. 15. In contrast, the follow-up reply cannot be viewed in a details page as illustrated in FIG. 13 corresponding to user C acting as the peer communication party.

In a team scenario, if only a single team is involved, then a user may manually set a reply mode for messages. However, if multiple teams are involved, e.g., cross-team communication is required, then the system may automatically set the reply mode for the messages to private mode in order to guarantee privacy of the communication content.

### Exemplary Team-Based Communication Method

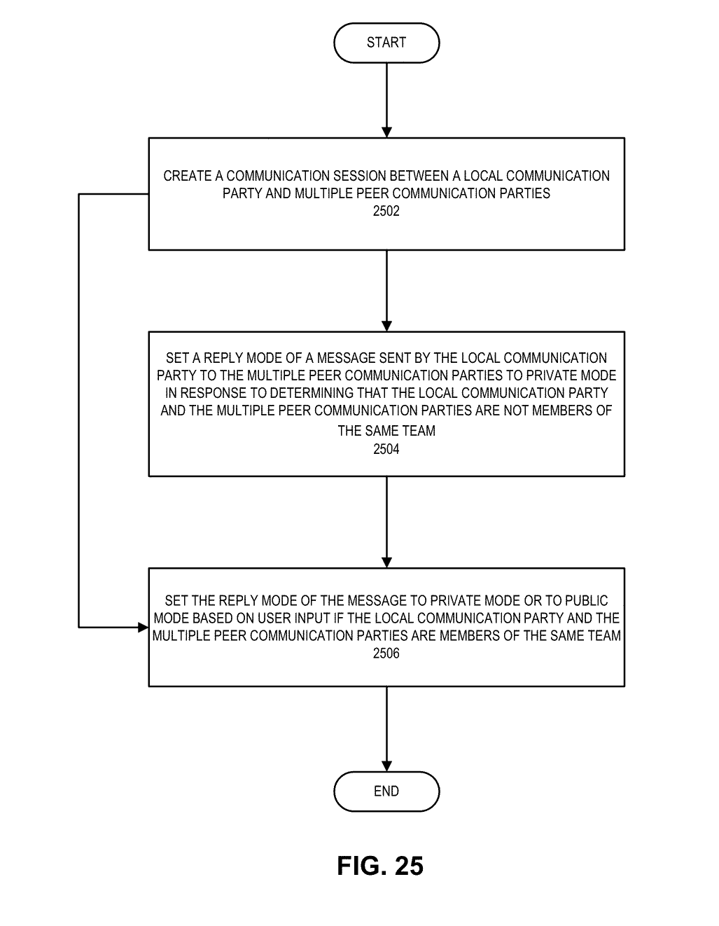

FIG. 25 presents a flowchart illustrating an exemplary process for a team-based communication method, in accordance with an embodiment. Based on a current team scenario, an electronic device of a local communication party may automatically set the reply mode for messages to accommodate different scenarios. Information security is thereby guaranteed, and user operation is simplified accordingly. As illustrated in FIG. 25, an electronic device operated by the local communication party may perform the method, and the operations of the method are as described below.

The system (e.g., electronic device of the local communication party) may create a communication session between a local communication party and multiple peer communication parties (operation 2502).

In some embodiments, depending on the communication means in use, there may be differences between the forms of communication sessions to a certain extent. For example, the local communication party may add multiple peer communication parties as members of a group by creating the group, so that a communication session may be a chat session of the group. Further, for example, the local communication party may create a reminder message, and the multiple peer communication parties are regarded as being recipients of the reminder message, so that a communication session may be a message session of the reminder message.

The system may set a reply mode of a message sent by the local communication party to the multiple peer communication parties to private mode in response to determining that the local communication party and the multiple peer communication parties are not members of the same team (operation 2504). Note that reply messages are sent only to the communication parties with permission to view the reply messages among the local communication party and the multiple peer communication parties when any peer communication party sends reply messages directed to the message.

In some scenarios, the local communication party and the multiple peer communication parties may have inconsistent team membership information. That is, the local communication party and the multiple peer communication parties are not on the same team. Due to information confidentiality requirements, the system may automatically set messages sent by the local communication party to private mode. For improved information security, a communication party may not freely view a reply message sent by another communication party. For example, in the cross-team group described with respect to FIG. 16, the cross-team group may use private mode by default.

The system may set the reply mode of the message to private mode or to public mode based on user input if the local communication party and the multiple peer communication parties are members of the same team (operation 2506).

If the local communication party and the multiple peer communication parties have consistent team membership information, this indicates that the communication session is a communication process within a team, and under these circumstances there is usually no requirement for privacy. The system may set the default mode to public mode. That is, every communication party may view reply messages sent by all communication parties. The local communication party may manually switch the reply mode to private mode to meet the privacy requirements for specific scenarios. For example, changing to private mode may be appropriate if there is financial information discussed between multiple users or departments, or if the communication involves confidential items of a confidential department. For example, for an intra-team group, the system may provide a control for “Group Message Private Mode” option 1702 as illustrated in FIG. 17 for switching between private mode and public mode.

### Exemplary Electronic Device

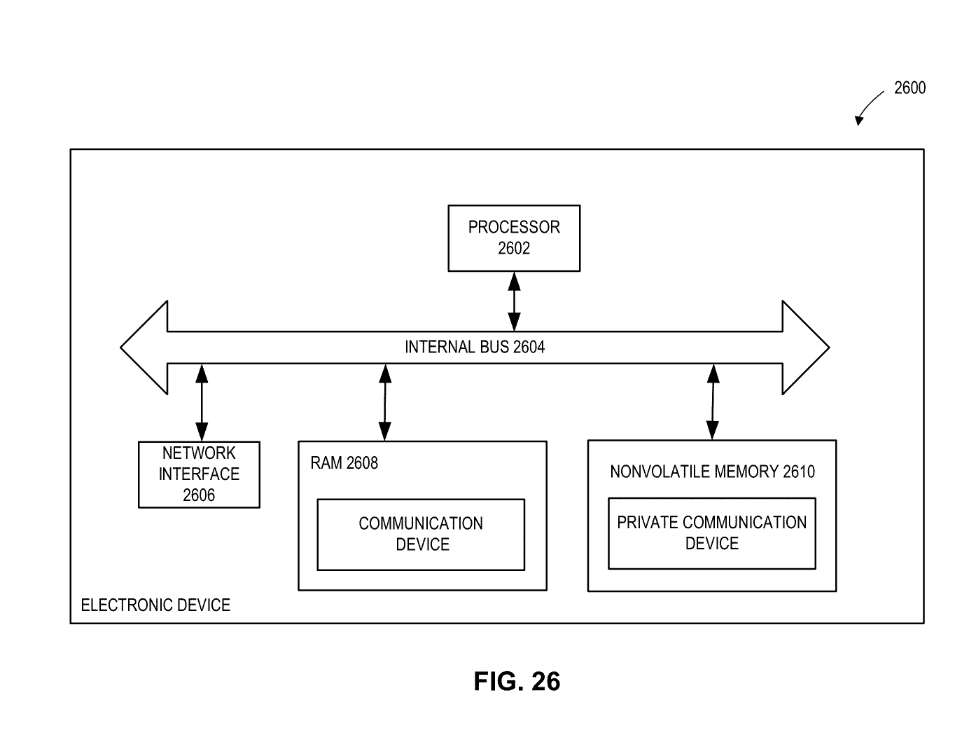

FIG. 26 presents a schematic diagram illustrating an exemplary electronic device 2600, in accordance with an embodiment. Electronic device 2600 may represent a communication device. At the hardware level, electronic device 2600 may include a processor 2602, an internal bus 2604, a network interface 2606, random access memory (RAM) 2608, and nonvolatile memory 2610. The electronic device may include other components for private communication with multiple parties. Processor 2602 may read a corresponding computer program from nonvolatile memory 2610 and store the computer program in RAM 2608, and then execute the program.

### Exemplary Communication Device

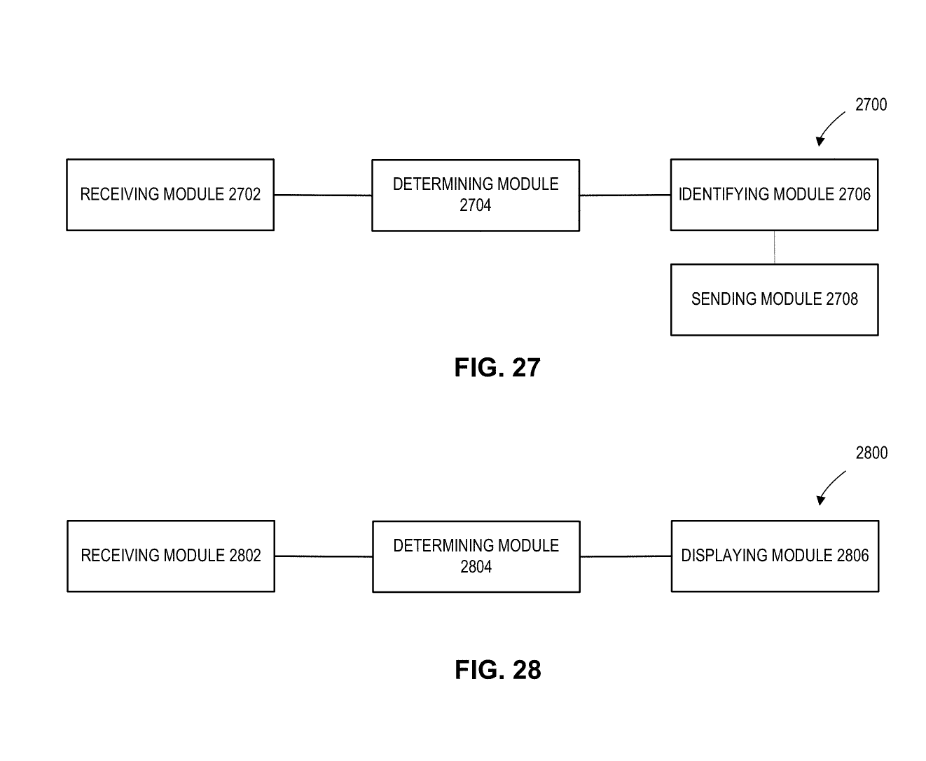

FIG. 27 presents a schematic diagram illustrating an exemplary communication device 2700, in accordance with an embodiment. Communication device 2700 may include application software installed on a client device. The device may include multiple components, including a receiving module 2702, a determining module 2704, an identifying module 2706, and a sending module 2708.

Receiving module 2702 may receive a message sent by a sender to multiple recipients. Receiving module 2702 may also receive a follow-up reply for a message from the sender, and may also receive information regarding one or more reply recipients (e.g., users that are to receive the follow-up reply) selected by the sender from among multiple recipients.

Determining module 2704 may determine that a reply mode of the message is set to a private mode which restricts permission to view replies to the message.

Optionally, the message is a reminder message sent by the sender to the multiple recipients.

Optionally, the system may display a control for a message configuration option in a page for creating the reminder message, and the sender may operate the control to set the reply mode of the reminder message.

Optionally, the sender and the multiple recipients are members of a group, and the message is a group message sent by the sender to the group.

Optionally, the system may display a control for a group configuration option in an administration page for the group. The sender may set the group configuration option to configure the group, and messages sent to the group are all set to private mode if the group is set as a private group.

Optionally, the communication party with viewing permission includes at least one of a first recipient specified by the sender, a second recipient specified by a recipient, a team member recipient that is a member of the same team as the sender, and a second team member recipient that is a member of a same second team as a recipient.

Identifying module 2706 may identify, among the sender and the multiple recipients, a communication party with permission to view the reply message.

Sending module 2708 may send the reply message to the identified communication party.

In some embodiments, receiving module 2702 may also receive a second message from the sender, in which the second message is set to the private mode if the sender and the multiple recipients are not on a same team. Receiving module 2702 may also receive a second message from the sender, in which the second message is set to at least one of the private mode and a public mode if the sender and the multiple recipients are on a same team. Furthermore, sending module 2708 may also send a follow-up reply to selected reply recipients.

### Exemplary Communication Device

FIG. 28 presents a schematic diagram illustrating an exemplary communication device 2800, in accordance with an embodiment. Communication device 2800 may include application software installed on a client device. The device may include multiple components, including a receiving module 2802, a determining module 2804, and a displaying module 2806.

Receiving module 2802 may receive a message generated by at least one of a sender and a recipient during a communication process between the sender and a plurality of recipients.

Determining module 2804 may determine that a reply mode of the message is set to a private mode which restricts permission to view replies to the message.

Displaying module 2806 may display, in a presentation area for the message, corresponding mode identification information which indicates the reply mode of the message is set to the private mode.

Displaying module 2806 may also display information that identifies a peer communication party with permission to view an input message entered in response to the message. Only the peer communication party with permission to view the input message receives the input message

### Exemplary Communication Device

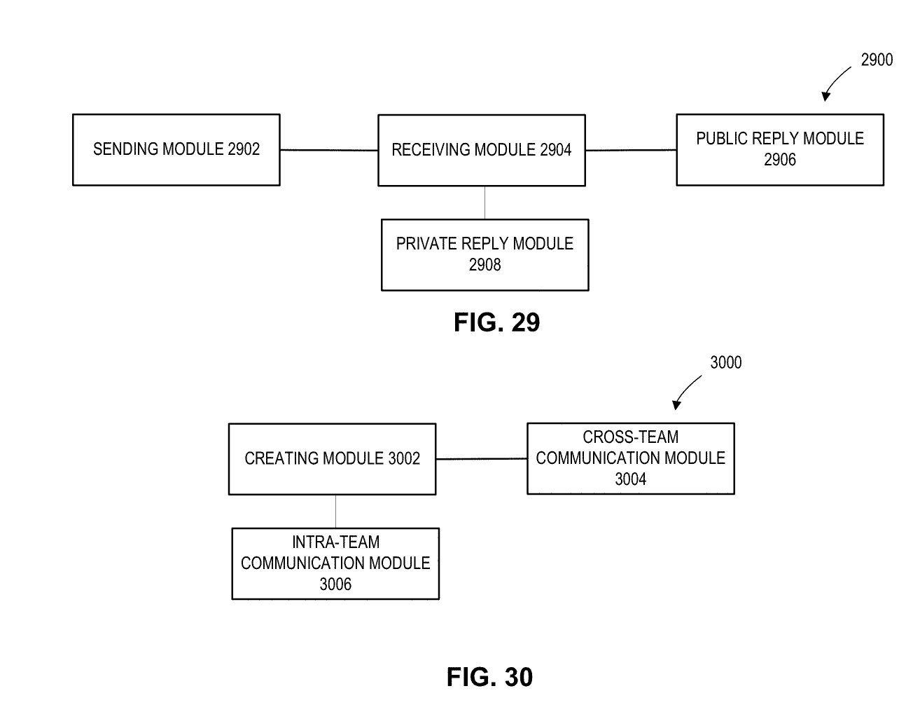

FIG. 29 presents a schematic diagram illustrating an exemplary communication device 2900, in accordance with an embodiment. Communication device 2900 may include application software installed on a client device. The device may include a sending module 2902, a receiving module 2904, a public reply module 2906, a private reply module 2908.

Sending module 2902 may allow a device associated with a sender to send a message to multiple recipients, in which a reply mode of the message is set to a private mode which restricts permission to view replies to the message.

Receiving module 2904 may receive a reply message sent by a recipient, wherein the reply message is sent only to one or more communication parties with permission to view the reply message among the sender and the multiple recipients.

Public reply module 2906 may set the multiple recipients to be recipients of a follow-up reply in response to the sender selecting an input area on a presentation page associated with the message to input the follow-up reply.

Private reply module 2908 may set the recipient to receive a second follow-up reply in response to the sender selecting the reply message sent by the recipient.

### Exemplary Communication Device

FIG. 30 presents a schematic diagram illustrating an exemplary communication device 3000, in accordance with an embodiment. Communication device 3000 may include application software installed on a client device. The device may include a creating module 3002, a cross-team communication module 3004, and an intra-team communication module 3006.

Creating module 3002 may create a communication session between the sender and multiple recipients.

Cross-team communication module 3004 may set a reply mode of a message sent by the sender to the multiple recipients to private mode in response to determining that the sender and the multiple recipients are not members of a same team, wherein a reply message is sent only to a communication party with permission to view the reply message among the sender and the multiple recipients.

Intra-team communication module 3006 may allow the local communication party to set a reply mode of a message to the private mode or to a public mode in response to determining that the sender and the multiple recipients are members of the same team.

### Exemplary Embodiments

The embodiments disclosed herein include a system for private communication with multiple parties. During operation, the system may receive a message sent by a sender to multiple recipients. The system may determine that a reply mode of the message is set to a private mode which restricts permission to view replies to the message. The system may receive a reply message sent by a recipient in response to the message. The system may identify, among the sender and the multiple recipients, a communication party with permission to view the reply message. The system may then send the reply message to the identified communication party.

In a variation on this embodiment, the message is a reminder message sent by the sender to the multiple recipients.

In a further variation, determining that the reply mode of the message is set to the private mode further includes determining that a message configuration option of the reminder message is configured by the sender to set the reply mode of the reminder message.

In a variation on this embodiment, the sender and the multiple recipients are members of a group, and the message is a group message sent by the sender to the group.

In a further variation, the group is set as a private group and messages sent to the group are all set to the private mode.

In a variation on this embodiment, the communication party with permission to view the reply message includes at least one of the sender, a first recipient specified by the sender, a second recipient specified by the recipient, a first team member recipient that is a member of a same team as the sender, and a second team member recipient that is a member of a same second team as the recipient.

In a variation on this embodiment, the system may receive, from the sender, a follow-up reply associated with the message. The system may receive data indicating a particular recipient selected by the sender from among the multiple recipients. The system may then send the follow-up reply to the particular recipient.

In a variation on this embodiment, the reply message is sent only to the identified communication party.

In a variation on this embodiment, the sender and the multiple recipients are not members of a same team. The system may receive a second message with a reply mode that is set to the private mode from the sender.

In a variation on this embodiment, the sender and the multiple recipients are members of the same team. The system may receive a second message from the sender, in which a reply mode of the second message is set to at least one of the private mode and a public mode.

Another embodiment disclosed herein includes a client system to perform a method for communication. During operation, the system may receive a message generated by at least one of a sender and a recipient during a communication process between the sender and a plurality of recipients. The system may determine that a reply mode of the message is set to a private mode which restricts permission to view replies to the message. The system may then display, in a presentation area for the message, corresponding mode identification information which indicates the reply mode of the message is set to the private mode.

In a variation of this embodiment, the system may display information that identifies a specific recipient with permission to view an input message entered in response to the message, in which only the specific recipient with permission to view the input message receives the input message.

In a variation of this embodiment, the recipient with the permission to view the input message includes at least one of a sender, a first recipient specified by the sender, a second recipient specified by a recipient, a first team member recipient that is a member of a same team as the sender, and a second team member recipient that is a member of a same second team as the recipient.

In a variation on this embodiment, the system may display a control for a message configuration option on a page for creating the message. The system may then receive user input to configure the control for the message configuration option to set the reply mode of the message.

In further variation, the system may also receive user input to enter a follow-up reply associated with the message. The system may receive user input which selects a particular recipient from among the plurality of recipients, and send the follow-up reply to the particular recipient.

In a variation on this embodiment, the system may display an administration page with a group configuration option for a group, and receive user input to configure the group configuration option to set the group to one of a private group or a public group. Note that a message sent to the group is set to the private mode if the group is set as a private group.

In a variation on this embodiment, the system may receiving user input to create a group, in which the group includes group members that are not a member of any team and group members from another team that is different from a team associated with the sender.

In a variation on this embodiment, the system may determine that a group member of the group is not a member of any team, and sets a group message sent by the sender to the private mode.

Another embodiment disclosed herein includes a system for communication. During operation, a device associated with a sender may send a first message to multiple recipients, in which a reply mode of the first message is set to a private mode which restricts permission to view replies to the first message. The system may receive a reply message sent by a recipient, in which the reply message is sent only to one or more reply recipients with permission to view the reply message among the sender and the multiple recipients.

The system may set the multiple recipients to be recipients of a follow-up reply in response to the sender selecting an input area on a presentation page associated with the first message to input the follow-up reply. The system may then set the recipient to receive a second follow-up reply in response to the sender selecting the reply message sent by the recipient.

In a variation on this embodiment, the system may create a communication session between the sender and the multiple recipients.

The system may set a message reply mode of a message sent by the sender to the multiple recipients to the private mode in response to determining that the sender and the multiple recipients are not members of a same team. Note that a reply message is sent only to a communication party with permission to view the reply message among the sender and the multiple recipients.

In some scenarios, the system may set a reply mode of the first message to the private mode or to a public mode based on user input in response to determining that the sender and the multiple recipients are members of the same team.

Another embodiment disclosed herein includes an apparatus for group communication. The apparatus may include a receiving module, a determination module, and a display module.

The receiving module may receive a message generated by at least one of a sender and a recipient during a communication process between the sender and a plurality of recipients.

The determination module may determine that a reply mode of the message is set to a private mode which restricts permission to view replies to the message.

The display module may display, in a presentation area for the message, corresponding mode identification information which indicates the reply mode of the message is set to the private mode. The display module may also display information that identifies a recipient with permission to view an input message entered in response to the message, in which only the recipient with permission to view the input message receives the input message.

Another embodiment disclosed herein includes an apparatus for group communication. The apparatus may include a sending module, a receiving module, a public reply module, and a private reply module.

The sending module may facilitate sending a message to multiple recipients by a device associated with a sender. The reply mode of the message may be set to a private mode which restricts permission to view replies to the message.

The receiving module may receive a reply message sent by a recipient, in which the reply message is sent only to one or more reply recipients with permission to view the reply message among the sender and the multiple recipients.

The public reply module may set the multiple recipients to be recipients of a follow-up reply in response to the sender selecting an input area on a presentation page associated with the message to input the follow-up reply.

The private reply module may set the recipient to receive a second follow-up reply in response to the sender selecting a reply message sent by the selected recipient.

Another embodiment disclosed herein includes an apparatus for group communication. The apparatus may include a creation module, a cross-team communication module, and an intra-team communication module.

The creation module may create a communication session between a sender and a plurality of recipients.

The cross-team communication module may set a message reply mode of a second message sent by the sender to the plurality of recipients to the private mode in response to determining that the sender and the plurality of recipients are not members of a same team. The second reply message may be sent only to a communication party with permission to view the second reply message among the sender and the plurality of recipients.

The intra-team communication module may receive user input to set the reply mode of the second message to private mode or to public mode if the sender and the plurality of recipients are members of the same team.

### Exemplary Mobile Communication Device

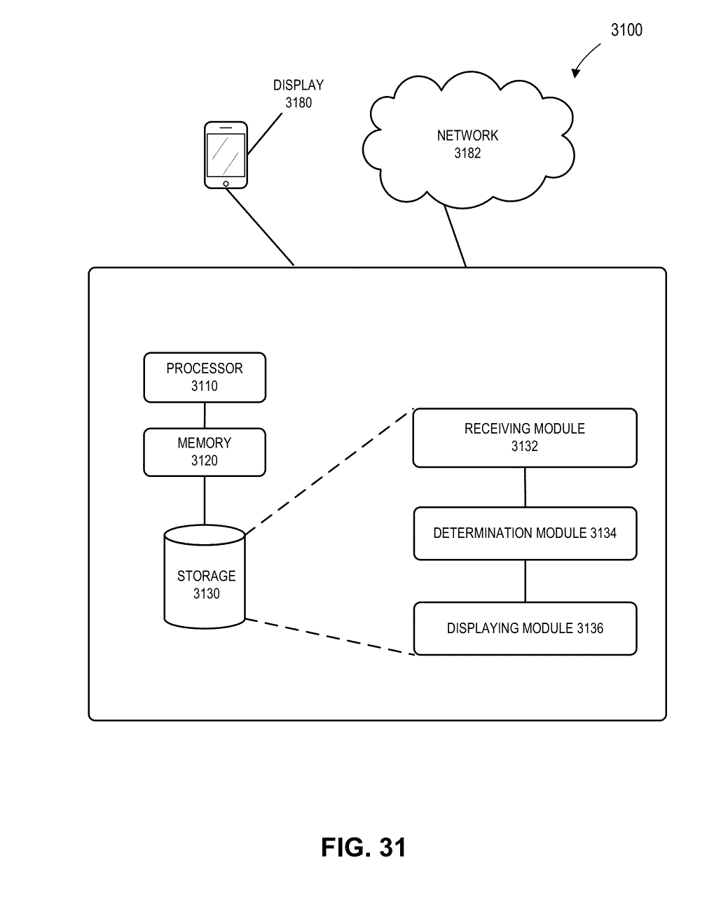

FIG. 31 presents a schematic diagram illustrating an exemplary mobile communication device 3100, in accordance with an embodiment. Mobile communication device 3100 may include a processor 3110, a memory 3120, and a storage device 3130. Storage 3130 typically stores instructions that can be loaded into memory 3120 and executed by processor 3110 to perform the methods described above. In one embodiment, the instructions in storage 3130 can implement a receiving module 3132, a determination module 3134, and a display module 3136, which can communicate with each other through various means.

In some embodiments, modules 3132-3136 can be partially or entirely implemented in hardware and can be part of processor 3110. Further, in some embodiments, the mobile communication device may not include a separate processor and memory. Instead, in addition to performing their specific tasks, modules 3132-3136, either separately or in concert, may be part of special-purpose computation engines.

Storage 3130 stores programs to be executed by processor 3110. Specifically, storage 3130 stores a program that implements a device for private communication with multiple parties. During operation, the application program can be loaded from storage 3130 into memory 3120 and executed by processor 3110. As a result, mobile communication device 3100 can perform the functions described above. Mobile communication device 3100 can further include a display 3180, and can be coupled via one or more network interfaces to a network 3182.

Receiving module 3132 may receive a message generated by at least one of a sender and a recipient during a communication process between the sender and a plurality of recipients.

Determination module 3134 may determine that a reply mode of the message is set to a private mode which restricts permission to view replies to the message.

Display module 3136 may display, in a presentation area for the message, corresponding mode identification information which indicates the reply mode of the message is set to the private mode.

### Exemplary Server

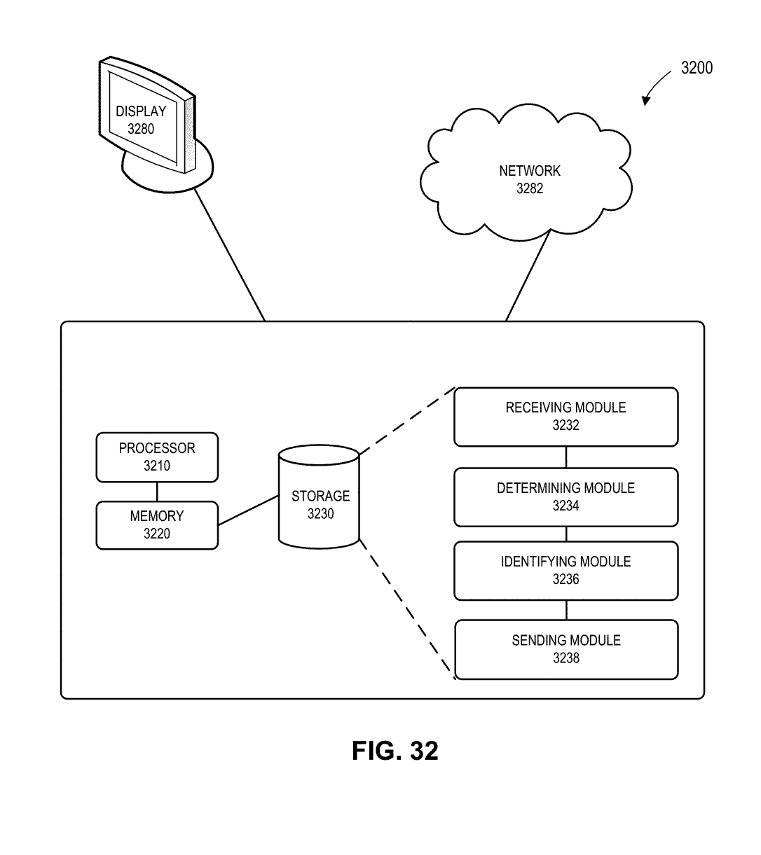

FIG. 32 presents a schematic diagram illustrating an exemplary server 3200 for private communication with multiple parties, in accordance with an embodiment. Server 3200 may include a processor 3210, a memory 3220, and a storage device 3230. Storage 3230 typically stores instructions that can be loaded into memory 3220 and executed by processor 3210 to perform the methods described above. In one embodiment, the instructions in storage 3230 can implement a receiving module 3232, a determining module 3234, an identifying module 3236, and a sending module 3238 which can communicate with each other through various means.

In some embodiments, modules 3232-3238 can be partially or entirely implemented in hardware and can be part of processor 3210. Further, in some embodiments, the server may not include a separate processor and memory. Instead, in addition to performing their specific tasks, modules 3232-3238, either separately or in concert, may be part of special-purpose computation engines.

Storage 3230 stores programs to be executed by processor 3210. Specifically, storage 3230 stores a program that implements a server (e.g., application) for private communication with multiple parties. During operation, the application program can be loaded from storage 3230 into memory 3220 and executed by processor 3210. As a result, server 3200 can perform the functions described herein. Server 3200 can further include an optional display 3280, and can be coupled via one or more network interfaces to a network 3282.

Receiving module 3232 may receive a message sent by a sender to multiple recipients. Receiving module 3232 may also receive a reply message sent by a recipient in response to the message.

Determining module 3234 may determine that a reply mode of the message is set to a private mode which restricts permission to view replies to the message.

Identifying module 3236 may identify, among the sender and the multiple recipients, a communication party with permission to view the reply message.

Sending module 3238 may send the reply message to the identified communication party.

The embodiments disclosed herein may be implemented on various universal or dedicated computer system environments or configurations. For example, the computer systems may include personal computers, server computers, handheld or portable devices, tablet-type devices, multiprocessor systems, microprocessor-based systems, set-top boxes, programmable electronic consumption devices, network PCs, minicomputers, mainframe computers, distributed computing environments including any of the above systems or devices, and the like.

The embodiments disclosed herein may be described within the general context of computer-executable instructions executed by a computer, such as a program module. Generally, the program module may include a routine, a program, an object, an assembly, a data structure and the like for implementing particular tasks or achieving particular abstract data types. The embodiments disclosed herein may also be implemented in distributed computing environments, in which tasks are performed by remote processing devices connected via a communication network. In the distributed computing environments, program modules may be located in local and remote computer storage media that may include a storage device.

The data structures and computer instructions described in this detailed description are typically stored on a computer-readable storage medium, which may be any device or medium that can store code and/or data for use by a computer system. The computer-readable storage medium may include, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The above description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments are not limited to those disclosed herein, but are to be accorded the widest scope consistent with the principles and features disclosed herein.

What is claimed is:

1. A computer-implemented method for communication, comprising:
receiving a message sent by a sender to multiple recipients;
determining that a reply mode of the message is set to a private mode which restricts permission to receive replies to the message;
receiving a reply message sent by a recipient in response to the message;
identifying, among the sender and the multiple recipients, a communication party with permission to receive the reply message; and
sending the reply message to the identified communication party.

2. The method of claim 1, wherein the message is a reminder message sent by the sender to the multiple recipients.

3. The method of claim 2, wherein determining that the reply mode of the message is set to the private mode further comprises:
determining that a message configuration option of the reminder message is configured by the sender to set the reply mode of the reminder message.

4. The method of claim 1, wherein the sender and the multiple recipients are members of a group, and the message is a group message sent by the sender to the group.

5. The method of claim 4, wherein the group is set as a private group and messages sent to the group are all set to the private mode.

6. The method of claim 1, wherein the communication party with permission to receive the reply message includes at least one of:
the sender,
a first recipient specified by the sender,
a second recipient specified by the recipient,
a first team member recipient that is a member of a same team as the sender, and
a second team member recipient that is a member of a same second team as the recipient.

7. The method of claim 1, further comprising:
receiving, from the sender, a follow-up reply associated with the message;
receiving data indicating a particular recipient selected by the sender from among the multiple recipients; and
sending the follow-up reply to the particular recipient.

8. The method of claim 1, wherein the reply message is sent only to the identified communication party.

9. The method of claim 1, wherein the sender and the multiple recipients are not members of a same team, further comprising:
receiving a second message with a reply mode which is set to the private mode from the sender.

10. The method of claim 1, wherein the sender and the multiple recipients are members of a same team, further comprising:
receiving a second message from the sender, wherein the second message is set to at least one of the private mode and a public mode.

11. A computer-implemented method for communication, comprising:
receiving a message generated by at least one of a sender and a recipient during a communication process between the sender and a plurality of recipients;
determining that a reply mode of the message is set to a private mode which restricts permission to receive replies to the message; and
displaying, in a presentation area for the message, corresponding mode identification information which indicates the reply mode of the message is set to the private mode.

12. The method of claim 11, further comprising:
displaying information that identifies a specific recipient with permission to receive an input message entered in response to the message, wherein only the specific recipient with permission to receive the input message receives the input message.

13. The method of claim 12, wherein the specific recipient with the permission to receive the input message includes at least one of:
a sender,
a first recipient specified by the sender,
a second recipient specified by a recipient,
a first team member recipient that is a member of a same team as the sender, and
a second team member recipient that is a member of a same second team as the recipient.

14. The method of claim 11, wherein the method further comprises:
displaying a control for a message configuration option on a page for creating the message; and
receiving user input to configure the control for the message configuration option to set the reply mode of the message.

15. The method of claim 14, wherein the method further comprises:
receiving user input to enter a follow-up reply associated with the message;
receiving user input which selects a particular recipient from among the plurality of recipients; and
sending the follow-up reply to the particular recipient.

16. The method of claim 11, wherein the method further comprises:
displaying an administration page with a group configuration option for a group; and
receiving user input to configure the group configuration option to set the group to one of a private group or a public group,
wherein a group message sent to the group is set to the private mode if the group is set as the private group.

17. The method of claim 11, further comprising:
receiving user input to create a group, wherein the group includes group members that are not a member of any team and group members from another team that is different from a team associated with the sender.

18. The method of claim 17, further comprising:
determining that a group member of the group is not a member of any team; and
setting a group message sent by the sender to the private mode.

19. A computer-implemented method for communication, comprising:
sending, by a device associated with a sender, a first message to multiple recipients, wherein a reply mode of the first message is set to a private mode which restricts permission to receive replies to the first message;
receiving a reply message sent by a recipient, wherein the reply message is sent only to one or more reply recipients with permission to receive the reply message among the sender and the multiple recipients;
setting the multiple recipients to be recipients of a follow-up reply in response to the sender selecting an input area on a presentation page associated with the first message to input the follow-up reply; and
setting the recipient to receive a second follow-up reply in response to the sender selecting the reply message sent by the recipient.

20. The method of claim 19, wherein the method further comprises:
creating a communication session between the sender and a plurality of recipients; and
setting a message reply mode of a second message sent by the sender to the plurality of recipients to the private mode in response to determining that the sender and the plurality of recipients are not members of a same team, wherein a second reply message is sent only to a communication party with permission to receive the second reply message among the sender and the plurality of recipients.
